(19) United States
(12) Patent Application Publication
(10) Pub. No.: US 2026/0333076 A1
(43) Pub. Date: Oct. 22, 2026

(54) PAIRING IDENTIFIERS FOR TWO-SIDED MACHINE LEARNING MODELS

(71) Applicant: Lenovo (United States) Inc., Morrisville, NC (US)

(72) Inventors: Tapisha Soni, Munich (DE); Joachim Löhr, Wiesbaden (DE); Vahid Pourahmadi, München (DE)

(73) Assignee: Lenovo (United States) Inc., Morrisville, NC (US)

(21) Appl. No.: 19/355,704

(22) Filed: Oct. 10, 2025

(51) Int. Cl. H04W 24/02

(52) U.S. Cl. CPC H04W 24/02

(57) ABSTRACT

Various aspects of the present disclosure relate to pairing identifiers for two-sided machine learning models. A network node, such as a user equipment (UE), receives an identifier for pairing at least two model parts associated with a two-sided machine learning model. The two-sided machine learning model includes a first model part configured for execution at the UE and a second model part configured for execution at another network node, such as a network entity (NE). The identifier identifies whether the first model part is paired with the second model part. The UE determines a status of the first model part based on the identifier, where the status indicates whether the first model part is applicable for inference at the UE. The UE transmits a report to the NE indicating the status and the identifier. In some examples, the UE receives the identifier as part of a request for the report.

### TECHNICAL FIELD

The present disclosure relates to wireless communications, and more specifically to artificial intelligence (AI) and machine learning (ML) model management.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive an identifier for pairing at least two model parts associated with a two-sided ML model, where the two-sided ML model includes a first model part configured for execution at the UE and a second model part configured for execution at a network node, where the identifier identifies whether the first model part is paired with the second model part. The UE may be configured to, capable of, or operable to determine a status of the first model part based on the identifier associated with the first model part, where the status is indicative of an applicability of the first model part for inference at the UE. The UE may be configured to, capable of, or operable to transmit a report that indicates the status of the first model part, where the report includes the identifier.

A processor for wireless communication is described. The processor may be configured to, capable of, or operable to perform one or more operations as described herein. For example, the processor may be configured to, capable of, or operable to receive an identifier for pairing at least two model parts associated with a two-sided ML model, where the two-sided ML model includes a first model part configured for execution at the UE and a second model part configured for execution at a network node, where the identifier identifies whether the first model part is paired with the second model part. The processor may be configured to, capable of, or operable to determine a status of the first model part based on the identifier associated with the first model part, where the status is indicative of an applicability of the first model part for inference at the UE. The processor may be configured to, capable of, or operable to transmit a report that indicates the status of the first model part, where the report includes the identifier.

A method performed or performable by a UE for wireless communication is described. The method may include receiving an identifier for pairing at least two model parts associated with a two-sided ML model, where the two-sided ML model includes a first model part configured for execution at the UE and a second model part configured for execution at a network node, where the identifier identifies whether the first model part is paired with the second model part. The method may include determining a status of the first model part based on the identifier associated with the first model part, where the status is indicative of an applicability of the first model part for inference at the UE. The method may include transmitting a report that indicates the status of the first model part, where the report includes the identifier.

In some implementations of the UE, the processor, and the method described herein, the status is determined based on at least one of a set of inference parameters, an availability of the first model part at the UE, one or more UE conditions, one or more network conditions, one or more deployment criteria associated with the two-sided ML model, or one or more training parameters associated with the two-sided ML model. In some implementations of the UE, the processor, and the method described herein, the UE may receive an inference configuration for the two-sided ML model based on the report, where the inference configuration includes the identifier and a set of inference parameters. In some implementations of the UE, the processor, and the method described herein, the UE may activate the first model part in response to receiving the inference configuration and based on the status of the first model part being applicable. In some implementations of the UE, the processor, and the method described herein, the inference configuration indicates one or more conditions for activation or deactivation of the first model part at the UE.

In some implementations of the UE, the processor, and the method described herein, the report further indicates one or more of a respective status and a respective identifier for each two-sided learning model of a set of two-sided ML models configured at the UE, or at least one set of inference parameters associated with the identifier. In some implementations of the UE, the processor, and the method described herein, the UE may transmit, in response to a capability request, a capability report indicating a set of machine learning model functionalities supported by the UE, where the identifier is received as part of an inference configuration in response to the capability report, and where the inference configuration corresponds to a machine learning model functionality of the set of machine learning model functionalities. In some implementations of the UE, the processor, and the method described herein, the UE may detect a change in the status of the first model part and transmit an updated report indicating the change in the status, where the updated report includes the identifier.

In some implementations of the UE, the processor, and the method described herein, the UE may receive a model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers, and determine a status of at least one model part corresponding to at least one identifier of the one or more identifiers. In some implementations of the UE, the processor, and the method described herein, the model switching command is received in response to the report or an updated report. In some implementations of the UE, the processor, and the method described herein, the UE may transmit a request to switch to a model part, the request including an identifier associated with the model part. In some implementations of the UE, the processor, and the method described herein, the identifier is associated with a dataset used to train the two-sided ML model.

An NE for wireless communication is described. The NE may be configured to, capable of, or operable to perform one or more operations as described herein. For example, the NE may be configured to, capable of, or operable to transmit, to a UE, an identifier for pairing at least two model parts associated with a two-sided ML model, where the two-sided ML model includes a first model part configured for execution at the UE and a second model part configured for execution at the NE, where the identifier identifies whether the first model part is paired with the second model part. The NE may be configured to, capable of, or operable to receive, from the UE, a report that indicates a status of the first model part corresponding to the identifier, where the report includes the identifier, and where the status is indicative of an applicability of the first model part for inference at the UE.

A processor for wireless communication is described. The processor may be configured to, capable of, or operable to perform one or more operations as described herein. For example, the processor may be configured to, capable of, or operable to transmit, to a UE, an identifier for pairing at least two model parts associated with a two-sided ML model, where the two-sided ML model includes a first model part configured for execution at the UE and a second model part configured for execution at the NE, where the identifier identifies whether the first model part is paired with the second model part. The processor may be configured to, capable of, or operable to receive, from the UE, a report that indicates a status of the first model part corresponding to the identifier, where the report includes the identifier, and where the status is indicative of an applicability of the first model part for inference at the UE.

A method performed or performable by an NE for wireless communication is described. The method may include transmitting, to a UE, an identifier for pairing at least two model parts associated with a two-sided ML model, where the two-sided ML model includes a first model part configured for execution at the UE and a second model part configured for execution at the NE, where the identifier identifies whether the first model part is paired with the second model part. The method may include receiving, from the UE, a report indicating a status of the first model part corresponding to the identifier, where the report includes the identifier, and where the status is indicative of an applicability of the first model part for inference at the UE.

In some implementations of the NE, the processor, and the method described herein, the NE may transmit, to the UE, an inference configuration for the two-sided ML model, where the inference configuration includes the identifier and a set of inference parameters. In some implementations of the NE, the processor, and the method described herein, the NE may select the identifier based on a status of the second model part at the NE, and where the status is indicative of an applicability of the second model part for inference at the NE. In some implementations of the NE, the processor, and the method described herein, the identifier is transmitted as part of a request for the report. In some implementations of the NE, the processor, and the method described herein, the NE may receive, from the UE, an updated report indicating a change in the status of the first model part, where the updated report includes the identifier. In some implementations of the NE, the processor, and the method described herein, the NE may transmit a model switching command in response to receiving the report, the model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers.

### BRIEF DESCRIPTION OF THE DRAWINGS

FIG. 1 illustrates an example of a wireless communications system in accordance with aspects of the present disclosure.

FIG. 2 illustrates an example of a model functional framework, in accordance with aspects of the present disclosure.

FIGS. 3 and 4 illustrate examples of block diagrams for two-sided ML model structures, in accordance with aspects of the present disclosure.

FIGS. 5 and 6 illustrate examples of model and inference parameter configurations, in accordance with aspects of the present disclosure.

FIGS. 7 through 11 illustrate examples of signaling diagrams, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a UE in accordance with aspects of the present disclosure.

FIG. 16 illustrates a flowchart of a method performed by an NE in accordance with aspects of the present disclosure.

### DETAILED DESCRIPTION

In a wireless communications system, a UE and an NE (e.g., a base station, gNB, or other network node) may support artificial intelligence (AI) and machine learning (ML) to reduce overhead, improve performance, and reduce latency. AI/ML models can be implemented in a wide range of scenarios and for a variety of purposes, such as for channel state information (CSI) feedback compression and enhancement, beam management (e.g., temporal domain beam management, spatial domain beam management), modulation and demodulation, scheduling, interference management, positioning, radio resource management (RRM) measurement prediction (e.g., temporal domain measurement prediction, spatial domain measurement prediction, frequency domain measurement prediction), measurement event prediction, and so forth. Such purposes, implemented by an AI/ML model, are interchangeably referred to herein as AI/ML “features,” “functionalities,” or the like, among other examples. AI/ML functionalities in wireless communications systems rely on life cycle management (LCM) processes and functions such as model training, model testing, model performance monitoring, and model inference. Models implemented for a given use case may be tailored toward, applicable to, and trained for particular datasets, scenarios, configurations, locations, and deployments, among other examples. Models may undergo updates (e.g., model changes) as part of their development and as they are trained. In some examples, multiple nodes (e.g., UEs and NEs) of the wireless communications system may be involved in an AI functionality. Each node may perform one or more LCM tasks, and data, configurations, parameters, outputs, and the like may be communicated between nodes. For example, multiple nodes or servers internal/external to the core network may collect data for training a model. The nodes may communicate the collected data to an NE, which may perform the training.

In contrast to one-sided models where the entire model operates at a single node, a two-sided AI/ML model includes a first model part configured to operate at a first node (also referred to as a node A) and a second model part configured to operate at a second node (also referred to as a node B), where the first and second model parts cooperatively perform inference operations. Two-sided models (e.g., CSI compression models) reduce feedback information and overhead by reducing the amount of raw data communicated between nodes. For example, the first model part may include an encoding model that processes input data to generate a latent representation, while the second model part may include a decoding model that processes the latent representation to produce an output. Two-sided models may arise from training processes where data collection and model optimization occur across multiple nodes, with each node contributing data specific to its operating conditions and capabilities. Additionally, considering that the statistics of training data samples depend on the node types (e.g., network vendor, chipset vendor) that are involved during data collection, some models can only be trained and applied for specific vendors on both ends. Thus, for a single functionality, multiple instances of a model may exist, each referring to or otherwise specific to different vendors, cells, configurations, scenarios, or node conditions, among other examples.

In some cases, at the node A, there may be multiple models associated with different node Bs, while at the node B, there may be multiple models associated with different node As. Given multiple models for a single functionality, which may be scenario-specific, cell-specific, configuration-specific, condition-specific, etc., it is important that a suitable model is selected (e.g., by the node A and/or the node B) for each node, e.g., depending on conditions or a state of each node at the time of inference or at the time of model activation. Additionally, in comparison to one-sided models, two-sided models require the first and second model parts to match (e.g., pair) to obtain accurate outputs from inference. The model parts may be considered to match when they are trained together or are otherwise compatible, such as trained using the same dataset or inference parameters, based on the same conditions, etc.

Because one-sided models do not rely on pairing different model parts, network control and management (e.g., selection, activation, deactivation, switching) of an AI/ML functionality or model is relatively efficient. For instance, determining the applicability of an AI/ML functionality or model at a UE can be performed by an NE, e.g., based on a network configuration for AI/ML inference, as the applicability primarily depends on model availability, network configuration, conditions at the network side, and/or conditions at the UE. In contrast, two-sided models rely on coordination between multiple nodes to ensure that a suitable model for AI/ML functionality can be selected and activated while ensuring consistency in training and inference. Thus, existing LCM frameworks for managing individual models at single nodes (e.g., one-sided models) may not provide sufficient mechanisms to support the additional complexities of two-sided models. As an example, even if a node A (e.g., a UE) communicates supported AI/ML models and functionalities to a node B (e.g., an NE), the node B lacks awareness of which models are applicable for the current scenario or configuration. Consequently, the node B may configure the node A for an AI/ML functionality without knowing whether a compatible model exists at the node B. This forces the node A to fall back to legacy operations without coordination with the node B. Such lack of coordination between nodes regarding supported and applicable functionalities, configurations, and scenarios results in inefficient performance of AI/ML-enabled features. Additionally, for two-sided models, awareness of supported and applicable functionalities and configurations alone is not sufficient, because each node (e.g., node B) needs to also be aware of the supported/applicable model(s) at the other node (e.g., node A).

The techniques described herein support functionality-based LCM and model-ID-based LCM for two-sided AI/ML models by providing signaling procedures that enable coordination between network nodes for appropriate model selection and management. The described techniques introduce pairing identifiers that uniquely associate model parts across nodes, ensuring that compatible model parts are selected and activated together while maintaining consistency through training and inference. Existing UE capability frameworks are extended for AI/ML functionality such that supported AI/ML functionalities can be reported by a node upon capability enquiry from another node. For example, based on receiving a pairing identifier from an NE, a UE determines the applicability of a corresponding model part at the UE based on the pairing identifier. The UE transmits, to the NE, an applicability report indicating an applicability status of the model part corresponding to the model pair, enabling the NE to make informed decisions about model activation and configuration. The NE may, for instance, transmit an inference configuration for the model part to the UE if the model part is applicable at the UE and a corresponding model part at the NE (e.g., associated with the pairing identifier) is also applicable.

The UE may determine the applicability based on associated inference parameters, UE conditions, model availability, network conditions (if available), and deployment scenarios, among other examples. In some examples, the UE detects and reports changes in model applicability status. Additionally, or alternatively, the NE may dynamically activate or deactivate one or more model parts at the UE through transmission of a model switching command indicating an associated pairing ID(s).

Aspects of the present disclosure enable efficient coordination between nodes for two-sided model LCM through signaling procedures that convey information about model pairs, ensure synchronization during model activation and deactivation, coordinate model switching across nodes, and verify compatibility of inference parameters across paired model parts. For example, by introducing a pairing identifier that associates matched pairs of model parts, the described techniques enable nodes to effectively and efficiently communicate model-related information and instructions that are not supported by conventional approaches. Additionally, by enabling granular applicability reporting at the model pair level using pairing identifiers, the described techniques prevent scenarios where nodes operate with incompatible model parts that would result in degraded inference performance or operational failures. In this manner, the described techniques reduce latency and improve communications reliability and performance. Further, the techniques described herein introduce efficient model switching mechanisms, reducing signaling overhead while maintaining coordination between nodes and enabling more reliable and efficient AI/ML functionality deployment.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

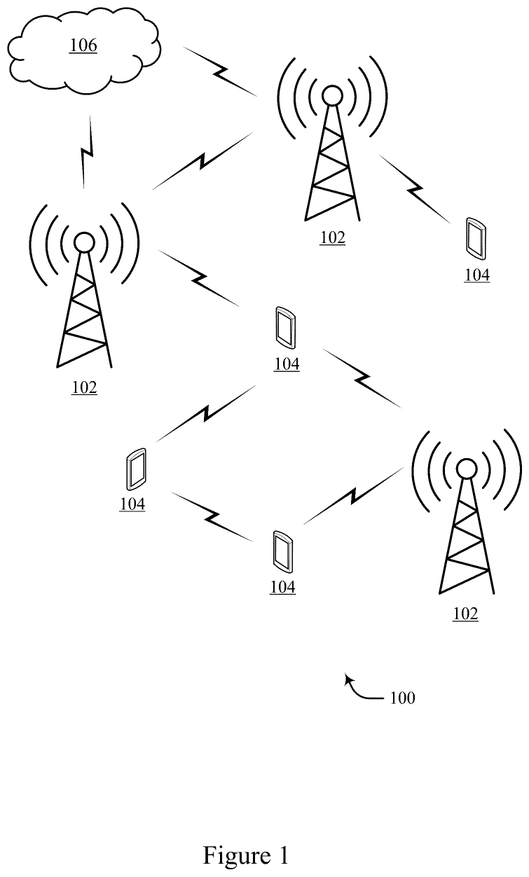

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the wireless communications system 100 can include one or more transmitting devices that transmit signaling, including data and/or control signaling, to one or more devices that receive the signaling (e.g., receiving devices). Example transmitting devices include, but are not limited to, NEs 102 and/or UEs 104. Additionally, or alternatively, example receiving devices include, but are not limited to, NEs 102 and/or UEs 104. The transmitting devices and the receiving devices can communicate via one or more channels (e.g., wireless channels). A channel includes a medium through which signaling propagate between the transmitting devices and the receiving devices. In some variations, the transmitting devices and/or the receiving devices can have multiple antennas. For example, a UE 104 can have r antennas and an NE 102 (e.g., base station or gNB) can have t antennas. A channel between the NE 102 and the UE 104 has a total of rt number of paths. A path defines a route or trajectory that an electromagnetic wave takes from a transmitting device to a receiving device. A signal can follow one or more paths from a transmitting device to a receiving device due to propagation, such as reflection, diffraction, and scattering.

In downlink communication, in which an NE 102 transmits signaling to a UE 104, a discrete-time channel can be represented as a r×t dimensional complex-valued matrix H, with element hᵢⱼ of H denoting the complex-valued channel gain between i^{th} receive antenna and j^{th} transmit antenna, 1≤i≤r, 1≤j≤t. A discrete-time channel refers to a channel in which transmitted signals and received signals are represented and processed in discrete time instants or intervals. That is, the wireless communications system 100 uses discrete-time samples of signals rather than continuous-time signals. The channel gains, or the channel matrix H, depends on the physical propagation medium. The wireless channel is a time-varying channel due to the dynamic nature of the physical propagation medium. Further, the channel gains depend on the frequency the devices use for the signaling. For example, with a multicarrier waveform, such as OFDM, the channel matrix can have different values for different sub-carriers (e.g., frequencies) at a same instant of time. That is, the wireless channel matrix H is stochastic, varying across time, frequency, and spatial dimensions.

In some examples, one or more devices in the wireless communications system 100 can adapt a transmission method for a current channel realization and/or preprocess signaling to be transmitted according to a current channel realization to increase signaling throughput over a communication link while improving reliability of the communication link. A transmitting device can use CSI to achieve an adaptive transmission or to implement preprocessing at the transmitting device. For example, a transmitting device can determine a channel matrix H over a frequency range of operation (e.g., at respective subcarriers for OFDM and/or multi-carrier waveforms) when characteristics of a channel change.

One or more devices in the wireless communications system 100 may support models, functionalities, and features/feature groups that are based on or otherwise associated with AI/ML. A network node, such as an NE 102, may manage implementation and operation of one or more models, functionalities, and/or features at one or more UEs 104. For example, the NE 102 may transmit signaling instructing one or more UEs 104 to activate, deactivate, switch between, or fall back from a model or functionality. Additionally, or alternatively, the NE 102 may configure and instruct one or more UEs 104 to perform AI/ML-related tasks, which may include LCM functions such as data collection. For instance, a UE 104 may perform measurements, collect data, and transfer the data to the NE 102. The NE 102 can transmit, to the UE 104, a configuration for performing the data collection, where the configuration can indicate measurements to be performed, data to be collected, and other parameters. In some cases, a UE 104 can make decisions regarding AI/ML-related tasks, e.g., autonomously or by communicating requests to the NE 102.

An AI/ML feature may be defined as a capability, operation, behavior, procedure, task, etc. that leverages and/or is enabled by AI/ML. As described herein, the term “functionality” refers to an AI/ML feature at a granularity of a use-case or sub-use-case, applied for inference at a node (e.g., a UE 104, an NE 102). In some cases, the granularity of an AI/ML functionality can be at a level of configuration for a particular use-case (e.g., beam management) or sub-use-case (e.g., spatial domain beam management, temporal domain beam management). AI/ML functionalities include, but are not limited to, beamforming, beam management, measurement prediction, CSI prediction, CSI compression, channel estimation, and positioning, among other examples.

A network node (e.g., a UE 104, an NE 102) may be capable of supporting multiple AI/ML models, AI/ML features, and AI/ML functionalities/configurations. Additionally, different network nodes may be capable of supporting different combinations of the aforementioned. Thus, to ensure efficient management and operation, a UE 104 may report AI/ML capability-related information (e.g., UE capability information) to the network (e.g., to an NE 102), enabling the network to make appropriate decisions related to activation, deactivation, switching, fallback, and the like. AI/ML capability information can include indications of models, features, and/or functionalities supported by a UE 104. In some examples, a UE 104 reports AI/ML capability information periodically and/or in response to a trigger event, such as reception of a request from the NE 102.

Additionally, a network node (e.g., a UE 104, an NE 102) may be capable of supporting one or more AI/ML LCM functions, such as data collection, model training, inference, monitoring, and the like. Model training can involve measuring, collecting, logging, and transferring (e.g., transmitting, reporting) data. As an example, an NE 102 may configure multiple UEs 104 to collect and transfer data to the NE 102, and the NE 102 can use the received data to train, re-train, and fine-tune a model. A model may have a higher likelihood of providing a high precision inference outcome if the model is trained with the same conditions, additional conditions, scenarios, and/or configuration that are observed at the time of inference. Thus, collecting data from multiple UEs 104 can improve accuracy and efficiency in model training and implementation. In terms of UE and network behavior, model training may be treated independently from other AI/ML LCM functions, such as inference and monitoring. For example, a model can be trained and readily available at a UE 104 or it can be downloaded from a server, and then applied by the UE 104 for inference if applicable. As another example, performance monitoring of models is performed in close coordination with inference.

The techniques described herein support functionality-based LCM and model ID-based for two-sided AI/ML models. The described techniques provide for signaling procedures that support the exchange of information among different involved nodes to allow an appropriate AI/ML model selection for an AI/ML functionality. For example, the signaling procedures described herein convey information about model pairs, ensure synchronization between nodes during model activation and deactivation, and coordinate model switching across both nodes. Additionally, the described techniques introduce pairing identifiers that associate model parts between nodes, verify compatibility of inference parameters across paired model parts, and manage the lifecycle of model pairs rather than individual models. A pairing identifier may be defined as an identifier common to a model pair (e.g., at least two matching model parts) of a two-sided model, where a first model part of the model pair is located at a first node (e.g., node A) and a second model part of the model pair is located at a second node (e.g., node B). Both model parts of the model part are implemented (e.g., configured, activated, operated) at the respective nodes to perform inference. The pairing identifier may include a configuration identifier of an inference configuration associated with the model pair. Existing UE capability framework is extended for AI/ML functionality such that supported AI/ML functionalities can be reported by a node (e.g., a UE 104) upon capability enquiry (e.g., a capability request) from another node (e.g., an NE 102). An information element (IE) (e.g., AIML-Parameters) for AI/ML-specific parameters is introduced to indicate supported AI/ML functionalities in the UE capability report (e.g., UE-NR-Capability). In some examples, the capability request may include an identifier of a node type (e.g., vendor information) of a node, ensuring transparency between the involved nodes.

A supported AI/ML functionality may be defined as an AI/ML functionality for which a node contains or is capable of downloading one or more AI/ML models, while these models may be generalized or cell-specific. This may ensure that the UE has an AI/ML model that can be activated for the current state of each node and/or the current scenario if the models are applicable. Additionally, the described techniques assume that data collection for training different AI/ML models has already been performed and the models have been trained at respective nodes. A further fine-tuning of the trained AI/ML models can be performed after being deployed for inference.

For example, a UE 104 can receive a pairing identifier associated with a two-sided ML model, where the two-sided ML model includes a first model part configured to operate at the UE 104 and a second model part configured to operate at the NE 102. The pairing identifier uniquely associates the first and second model parts to ensure that compatible model parts are selected and activated together during inference operations. Two-sided models require the relevant parts from both sides to match or pair for generating accurate inference outputs, unlike one-sided models that operate entirely at a single node.

The UE 104 determines an applicability status of the first model part based on the pairing identifier. In some examples, the UE 104 determines the applicability status further based on associated parameters such as inference parameters, whether the first model part is available at the UE 104, UE conditions (e.g., battery status, memory, hardware limitations), network conditions, deployment scenarios, and/or training parameters associated with the two-sided ML model, among other examples. As described herein, an applicability status indicates whether the first model part can be activated for inference at the UE 104 under current conditions. For instance, a status of “applicable” indicates that a corresponding model part is available, can be activated, and is appropriate (e.g., based on corresponding conditions, operating parameters, training parameters, inference parameters, and so forth) for inference at the UE 104, while a status of “inapplicable” indicates that the model part is not available and/or is unobtainable at the UE 104, that current conditions at the UE 104 are not suitable for the model part, that a current configuration of the UE 104 does not support the model part, the model cannot be activated, or the like. As a specific example, a cell-specific model part may be inapplicable if the UE 104 is located in a cell different from that associated with the cell-specific model part.

The UE 104 transmits an applicability report to the NE 102 indicating the applicability status of the first model part. The applicability report includes an indication of the pairing identifier to enable the NE 102 to identify which specific model pair is being reported on. Based on the applicability report, the NE 102 can make informed decisions about model activation and configuration. For instance, if the first model part is applicable at the UE 104 and a corresponding second model part at the NE 102 is also applicable, the NE 102 may transmit an inference configuration for the two-sided ML model to the UE 104. The NE 102 may also transmit model switching commands to dynamically activate or deactivate model parts.

With reference to the utilization of AI/ML in wireless communications systems, the following represent some examples of relevant features and/or terminology.

AI/ML enabled feature: A feature where AI/ML may be used.

AI/ML functionality: An AI/ML-enabled feature or feature group enabled by configurations, where configurations can be supported based on conditions indicated by a UE.

AI/ML model: A data-driven algorithm that applies AI/ML techniques to generate a set of outputs based on a set of inputs.

Network-side (AI/ML) model: An AI/ML model whose inference is performed entirely at the network.

UE-side (AI/ML) model: An AI/ML model whose inference is performed entirely at the UE.

Functionality identification: A process or method of identifying an AI/ML functionality for a common understanding between an NE and a UE. The node at which an AI/ML functionality resides depends on the specific use cases and sub use cases.

Supported functionalities: A common understanding of functionalities operable by a UE and/or the network can be developed between the network and the UE. The functionalities can be said to be identified and/or supported.

Applicable functionalities: A subset of supported functionalities.

Additional conditions: Conditions that may vary for different scenarios, sites, or datasets. Examples of additional conditions include UE internal conditions such as battery, memory, hardware attributes, etc. There may be UE-side additional conditions and network-side (e.g., NE-side) additional conditions.

Associated identifiers (IDs): IDs referring to additional conditions. For example, UE-side additional conditions and/or network-side additional conditions may be represented by associated IDs.

Data collection: A process of collecting data by network nodes, management entities, and/or UEs for the purpose of model training, data analytics, and inference.

Dataset: A related set of information can be collectively called a dataset. Datasets may be defined for different purposes. For example, a dataset used for training may be referred to as a training dataset.

Management instruction: Information that can be used to ensure proper inference operation. This information may include selection, activation, deactivation, and/or switching of models and/or AI/ML functionalities, fallback to non-AI/ML operation, etc.

Activation: Enabling a model or model part for a specific AI/ML-enabled feature or functionality.

Deactivation: Disabling a model or model part for a specific AI/ML-enabled feature or functionality.

Model download: Model transfer from the network to a UE.

Model identification: A process and/or method of identifying a model or model part for a common understanding between the network and the UE. Information regarding a model or model part may be shared during model identification.

Model monitoring: A procedure that monitors the inference performance of a model.

Model parameter update: A process of updating model parameters of a model.

Selection: A process of selecting, for activation, a model or model part from among multiple models or model parts associated with the same AI/ML enabled feature or functionality. Model selection may or may not be carried out simultaneously with model activation.

Switching: Deactivating a currently active model or model part and activating a different model or model part for a specific AI/ML-enabled feature or functionality.

Model update: A process of updating model parameters and/or model structure of a model or model part.

Model upload: Model transfer from a UE to the network.

Two-sided model: A paired model over which joint inference is performed, where joint inference includes inference performed cooperatively between the UE and the network. For instance, a first model part may be located at a UE and a second model part may be located at an NE. As another example, an encoding part (at the UE) computes a quantized latent representation of the input data and communicates it to the NE, and a decoding part (at the NE) uses it to reconstruct the desired output.

UE state: A state of a UE can be defined as a UE state based on UE-side conditions, such as UE settings, UE internal conditions, additional conditions, a scenario, etc.

NE state: A state of an NE can be defined as a network state based on network-side conditions, such as NE settings, additional conditions, a scenario, a configuration, etc.

Scenario: A scenario can be defined as a deployment scenario that is categorized based on various factors, such as channel models (e.g., heavy line of sight/non-line of sight (LOS/NLOS) conditions, urban microcellular (UMi), urban macrocellular (UMa), indoor hotspot (InH)), outdoor/indoor UE distributions, carrier frequencies, UE speeds, antenna spacings, etc. For example, network-defined scenarios can be scenarios with network-defined dataset categorization. UE-defined scenarios can be scenarios with UE-defined dataset categorization.

Configuration: A configuration may be defined as a set of parameters and settings, and may be for a UE, the network, or some combination thereof. The parameters and settings can include, for example, bandwidth, UE speed, antenna port layouts, numerology, and the like. A UE configuration may define various UE parameters, such as a quantity of UE receive beams (including a quantity of panels and UE antenna array dimensions) and a UE codebook. An NE configuration may define various NE parameters, such as a downlink transmit beam codebook (including various Set A beam(pairs), various Set B beam(pairs), and NE antenna array dimensions).

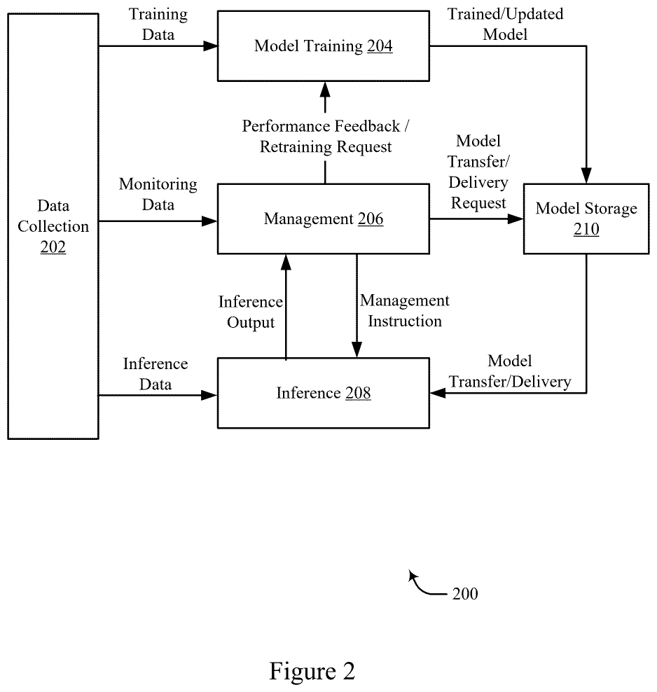

FIG. 2 illustrates an example of an AI/ML functional framework 200. In some examples, the AI/ML functional framework 200 implements or is implemented by aspects of the wireless communications system 100. For example, the AI/ML functional framework 200 can implement aspects of, or can be implemented by, a UE and/or a NE, which may be examples of a UE 104 and a NE 102 as described with reference to FIG. 1.

The AI/ML functional framework 200 includes a set of functionalities (e.g., AI/ML functionalities) implemented to operate and manage one or more learning models as described herein. The set of functionalities includes a data collection function 202, a model training function 204, a management function 206, an inference function 208, and a model storage function 210. It is to be understood that the examples described herein are for the purposes of illustration and are not to be construed as limiting. For example, the AI/ML functional framework 200 may include any quantity and combination of functionalities including functionalities not discussed herein.

The data collection function 202 can provide input data to the model training function 204, the management function 206, and the inference function 208. For example, the data collection function 202 provides training data as input for the model training function, monitoring data as input for the management function, and inference data as input for the inference function. The model training function 204 can perform model training, validation, and testing, and generates model performance metrics for use as part of model testing procedures. The model training function 204 is also responsible for data preparation (e.g., data preprocessing and cleaning, formatting, and transformation) based on the training data (e.g., as delivered by the data collection function).

Broadly, the management function 206 oversees the operation (e.g., selection, activation, deactivation, switching, fallback) and monitoring (e.g., performance monitoring) of models and/or functionalities. The management function 206 is further responsible for making decisions that ensure proper inference operation based on data received from the inference function 208 and the data collection function 202. For example, based on received data, the management function 206 can provide information, such as management instructions, as input to the inference function 208. Management instructions may include, but are not limited to, selection, activation, deactivation, and switching of models and/or functionalities, fallback to non-AI/ML operations (e.g., no longer relying on inference processes), and the like. The management function 206 may input model transfer and/or delivery requests to the model storage function 210 to request model(s) from the model storage function 210. Additionally, or alternatively, the management function 206 can input performance feedback and/or retraining requests to the model training function 204, e.g., for model training, re-training, or updating purposes.

The inference function 208 provides outputs obtained from the process of applying models and/or functionalities using the data input by the data collection function 202 (also referred to herein as inference data). The inference function 208 is further responsible for data preparation (e.g., data preprocessing and cleaning, formatting, and transformation) based on inference data delivered by the data collection function 202. Inference output refers to data provided by the inference function 208 to the management function 206 for monitoring the performance of models and/or functionalities. The model storage function 210 stores trained and updated models that can be used to perform the inference function 208.

LCM of models and functionalities (e.g., AI/ML models and functionalities) can include model-ID-based LCM and functionality-based LCM. As described herein, “functionality” refers to an AI/ML-enabled feature/FG enabled by one or more configurations that are, in turn, supported based on conditions indicated by UE capabilities. Thus, functionality-based LCM operates based on at least one configuration of an AI/ML-enabled feature or feature group. In functionality-based LCM, the network (e.g., an NE) indicates (e.g., to one or more other network nodes, such as UEs and/or NEs) selection, activation, deactivation, fallback, and switching of functionalities via 3GPP signaling (e.g., RRC, medium access control (MAC) control element (MAC-CE), downlink control information (DCI)). Models may not be identified at the network, and UEs may perform model-level LCM. A UE may have one or more models for a functionality. Functionality identification may be achieved by defining one or more functionalities within an AI/ML-enabled feature (e.g., a feature where AI/ML may be used). Whether and how much awareness and/or interaction the network should have about model-level LCM at a UE may require further study. Additionally, mechanisms and parameters for UE reporting of updates on applicable functionalities, where applicable functionalities include a subset of all functionalities, may be studied.

In model-ID-based LCM, models are identified at the network, and the network and/or a UE may activate, deactivate, select, and switch individual models via model IDs. Model-ID-based LCM operates based on identified models, where a model may be associated with particular configurations and/or conditions associated with UE capability of an AI/ML-enabled feature/FG, and with additional conditions (e.g., scenarios, sites, datasets) as determined or identified between the UE and the network. A model may be assigned a model ID during model identification, which may be communicated between nodes. A model ID can be used within functionalities and for different data/information/instruction flows to identify an AI/ML model. For example, a model ID may be associated with selection/(de)activation/switching of a model or linked to model transfer/delivery information associated with the model.

Additionally, once a model is identified, a UE may indicate model IDs for a given functionality or feature, e.g., as part of UE capability reporting. A model ID may or may not be globally unique, and different types of model IDs may be created for a single model for different LCM purposes. Once a functionality and/or a model is identified, the same or similar procedures may be used for activation, deactivation, switching, fallback, and monitoring. In some examples, a model ID can be used in a functionality for LCM operations. Further study may be useful regarding handling the impact of UE internal conditions (e.g., memory, battery, and other hardware limitations) on functionality and/or model operations and AI/ML-enabled features.

The AI/ML functional framework 200 enables application of AI/ML features and functionalities at a node (e.g., a UE, an NE). As part of UE capability and UE assistance information (UAI) procedures, a UE indicates AI/ML functionalities/use-cases/sub-use-cases (e.g., temporal beam management, CSI prediction, etc.) that it supports for inference. This UE capability information may be signaled autonomously by the UE and/or in response to reception of a capability request transmitted by the network (e.g., an NE).

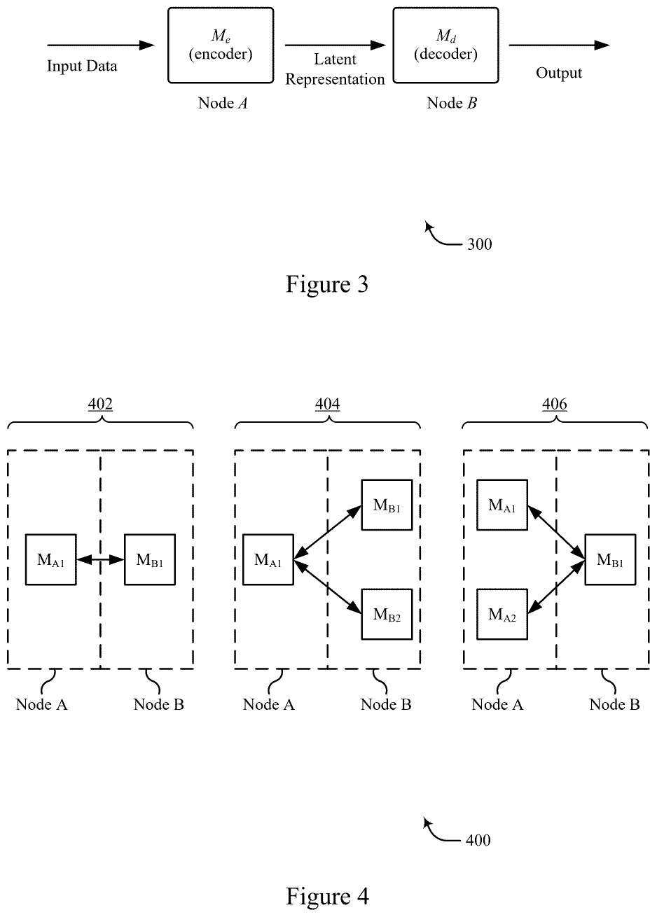

FIG. 3 illustrates a block diagram 300 for a two-sided model. In some examples, the two-sided model illustrated by the block diagram 300 implements or is implemented by aspects of the wireless communications system 100. The two-sided model in the block diagram 300 may be implemented by a node A and a node B, which each may be examples of a UE 104 or an NE 102 as described with reference to FIG. 1.

In a two-sided model, a first part (e.g., portion) of the model is located at a node A (e.g., an NE 102, a UE 104) and a second part (e.g., portion) of the model is located at a node B (e.g., an NE 102, a UE 104). The model part located at the node A may be referred to as M_{A}, and the model part located at the node B is referred to as M_{B}. In some examples, the model part M_{A} may include or be an example of an encoding model Mₑ, while the model part M_{B} may include or be an example of a decoding model M_{d}. The examples described herein are not to be construed as limiting, and the location of the encoder model and the decoder model may be alternated.

The node A may receive input data (e.g., by performing data collection or by receiving data from another node). As an example, the input data may be a dataset based on channel measurements. For example, the dataset may be raw channel inputs of Hₖ or Hₗₖ, or precoders that are computed from the channel matrix, e.g., the eigenvector associated with the largest eigen-vector of Hₖ for each subband. The node A may implement the encoding model Mₑ to compute a quantized latent representation of the input data and may transmit or otherwise communicate the latent representation to the node B. The node B can receive the latent representation and use the latent representation to reconstruct an output by implementing the decoding model M_{d}. This method reduces feedback information and the amount of raw data communicated between the node A and the node B.

FIG. 4 illustrates a block diagram 400 of model pairs at a node A and a node B. In some examples, the model pairs illustrated by the block diagram 400 implement or are implemented by aspects of the wireless communications system 100. For example, the node A and the node B each may include or be examples of a UE 104, an NE 102, or any other network node, as described with reference to FIG. 1.

The block diagram 400 illustrates pairing relationships (e.g., configurations, structures, architectures) 402, 404, and 406 of model parts of a two-sided ML model at the node A and the node B. Models may be tailored toward and applicable to various scenarios, configurations, locations, and deployments, among other factors. In this regard, models may undergo updates (e.g., model changes) as part of their development. As such, after model training, there may be multiple models, model parts, and/or sets of inference parameters at the node A side that are associated with different node Bs, and multiple models, model parts, and/or sets of inference parameters at the node B side that are associated with different node As.

Additionally, or alternatively, after training a two-sided model, there may be one or more model parts and/or sets of inference parameters at the node A that are paired with one or more model parts and/or sets of inference parameters at the node B, where each model part and set of inference parameters is associated with a two-sided ML model. As described herein, a “model pair” refers to a paired set of model parts, where a first model part is located at and configured for execution (e.g., to perform inference) at the node A and a second model part is located at and configured for execution (e.g., to perform inference) at the node B. Training of a two-sided model is performed based on an associated dataset corresponding to the model parts and the AI/ML functionality. For example, a model part at the network side can be trained using a dataset received from a corresponding model part at the UE side. For one dataset from a UE, the network may train one or more models at the network side based on different factors such as complexity of the models, accuracy of the models, network-side conditions, network configurations, and so forth. Similarly, the UE may train the UE part of the model(s) based on a dataset from the network, which may result in multiple models at the UE for the same dataset. Additionally, a UE may contain multiple models or model parts that are for a same purpose but mapped to different cells, different conditions, or different gNB vendors, among other examples.

In comparison to one-sided models, two-sided models require the relevant parts of the models from both sides to match (e.g., pair) for generating inference. As a specific example, for a particular functionality such as CSI compression, multiple model pairs may be trained using different sets of inference parameters, where each set may include configurations such as payload size, number of antennas, or subband parameters. The model pairs can be formed as one-to-many or many-to-one at the node A side and the node B side. When implementing the functionality, to ensure valid outputs, the node A and the node B must both use model parts trained on the same set of inference parameters, e.g., belonging to a same model pair. Additionally, the availability of a model or set of inference parameters at one node does not guarantee availability at a corresponding node. Thus, the node A and the node B must communicate to align use of the correct model parts prior to implementing or activating the functionality.

To this end, the techniques described herein provide for an identifier (e.g., a pairing identifier) common to (e.g., shared by, associated with, corresponding to) paired parts of a two-sided ML model. For example, one model pair may be trained with a first set of inference parameters while another model pair for the same functionality is trained with a different set of parameters, with each pair assigned a distinct pairing identifier. A pairing identifier corresponds to model parts on each node side of a pair that are associated with a same set of training parameters and inference configurations, enabling proper synchronization between compatible model parts during training and inference phases of LCM. Additionally, or alternatively, the pairing identifier may be part of or otherwise linked to the associated IDs that represent additional conditions for AI/ML applicability (e.g., as described with reference to FIG. 1). Pairing identifiers can be utilized through all LCM stages, including model training, inference operations, model monitoring, model fine-tuning, model switching, and data collection procedures.

For instance, during data collection for training, fine-tuning, or monitoring purposes, collected data can be associated with the pairing identifier of the corresponding model/model pair. For initial datasets collected for model training, a pairing identifier may be assigned to ensure that data from both sides of the model pair is properly associated and utilized during the training process. In some cases, the pairing identifier is mapped to an identifier of a dataset used during training. When model parts require fine-tuning after initial deployment, additional datasets can be associated with the same pairing identifier to ensure the supplemental data is applied to the correct model pair, maintaining consistency between the UE-side and network-side model parts. The pairing identifier may be assigned to a dataset before, during, or after the dataset is transmitted to a training server.

Following model deployment, ongoing data collection procedures can incorporate the pairing identifier. For example, when an NE provides a data collection configuration to a UE, the configuration may include the relevant pairing identifier to specify which model pair the collected data should support. When the UE reports data, the UE can include an indication of the corresponding pairing identifier, enabling the training server to update the appropriate dataset based on the pairing identifier association. This approach ensures that collected data is properly categorized and applied to the correct model pair during subsequent training, fine-tuning, or monitoring operations.

In the example of FIG. 4, the pairing relationship 402 illustrates a one-to-one correspondence between a model part M_{A1} at the node A and a model part M_{B1} at the node B, where the model part M_{A1} and the model part M_{B1} are a model pair associated with a same two-sided ML model. The model part M_{A1} may be configured for execution at the node A and the model part M_{B1} may be configured for execution at the node B. The model part M_{A1} and the model part M_{B1} are both associated with a same pairing identifier. In some examples, other parameters or information associated with the two-sided ML model may also be assigned the pairing identifier, such as one or more sets of inference parameters, one or more datasets (e.g., training datasets), an inference configuration, or the like, among other examples.

The pairing relationship 404 illustrates a one-to-many correspondence between the model part M_{A1} at the node A and two model parts, M_{B1} and M_{B2}, at the node B. This arrangement demonstrates a one-to-many pairing relationship where a single model part at the UE side may be paired with multiple model parts at the network side. The pairing relationship 406 depicts correspondence between a single model part M_{B1} at the node B and two model parts, M_{A1} and M_{A2}, at the node A. This configuration demonstrates a many-to-one pairing relationship where multiple model parts at the UE may be paired with a single model part at the network side.

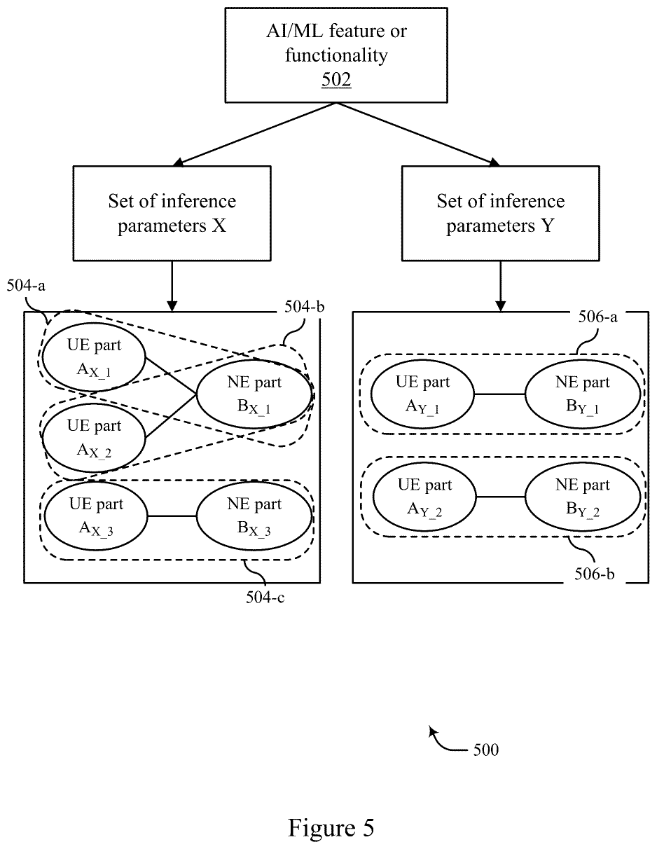

FIG. 5 illustrates a block diagram 500 of model pairs at a UE and an NE (e.g., a gNB or other base station supporting radio access technologies beyond NR). In some examples, the model pairs illustrated by the block diagram 500 implement or are implemented by aspects of the wireless communications system 100. For example, the UE and the NE may be examples of a UE 104 and an NE 102, respectively, as described with reference to FIG. 1. FIG. 5 depicts an example granularity for defining model pairs and their relations to sets of inference parameters.

An AI/ML functionality 502 may implement or be implemented by one or more two-sided models, such as by using different operational configurations and inference parameter sets. In the example of FIG. 5, each set of inference parameters corresponds to a set of model pairs, where each model pair includes a UE part and a NE part. An inference configuration may be defined as operational parameters and settings that define how a two-sided ML model performs inference operations, including the pairing identifier, inference parameters, and conditions for model activation or deactivation. Specifically, a set of inference parameters X is associated with model pairs 504-a, 504-b, and 504-c, while a set of inference parameters Y is associated with model pairs 506-a and 506-b. The model pair 504-a may include a UE part A_{X_1} and a NE part BX_1; the model pair 504-b may include a UE part A_{X_2} and a NE part B_{X_2}; and the model pair 504-c may include a UE part A_{X_3} and a NE part B_{X_3}. A set of inference parameters Y is associated with model pairs 506-a and 506-b. The model pair 506-a includes a UE part A_{Y_1} and a NE part B_{Y_1}, while the model pair 506-b includes a UE part A_{Y_2} and a NE part B_{Y_2}.

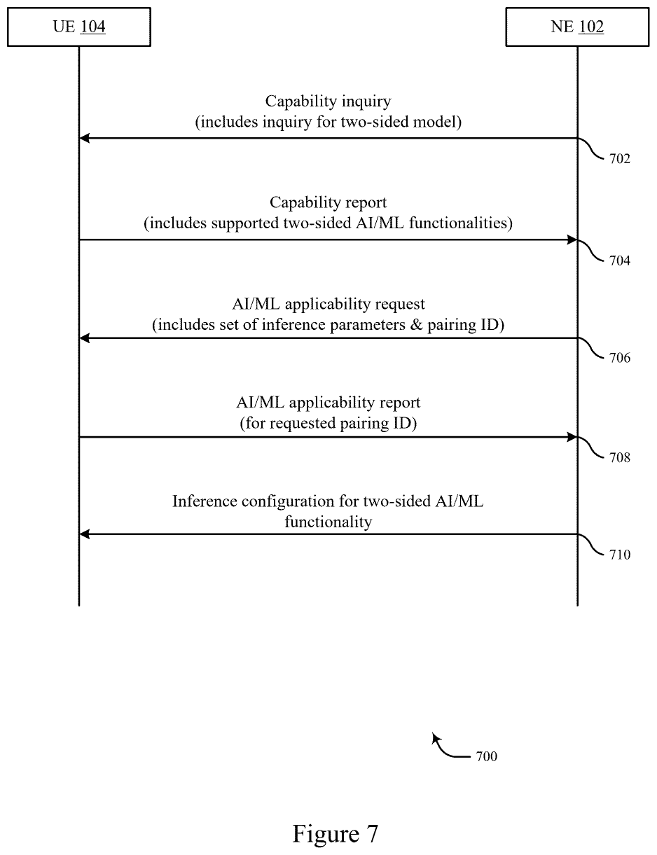

As illustrated by FIG. 5, for one inference configuration associated with a two-sided ML model, there may be one or more model parts at the UE side mapped to one model part at the network (e.g., NE) side. If the UE wishes to switch from one model to another under the same configuration, it is not required for the network to be aware of this in the case of one-sided models, as there is no network impact. In contrast, for two-sided models, the UE and the network need to synchronize on the exact model pair to be used, even if the inference configuration remains the same. As described in greater detail with reference to FIGS. 7-11, an applicability status reporting framework can be used for two-sided models.

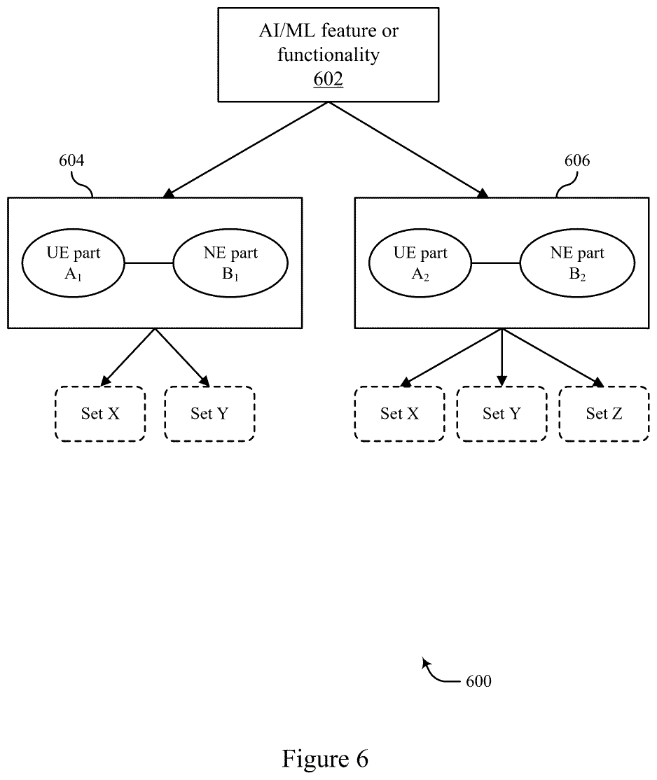

FIG. 6 illustrates a block diagram 600 of model pairs at a UE and an NE (e.g., a gNB or other base station supporting radio access technologies beyond NR). In some examples, the model pairs illustrated by the block diagram 600 implement or are implemented by aspects of the wireless communications system 100. For example, the UE and the NE may be examples of a UE 104 and an NE 102, respectively, as described with reference to FIG. 1. FIG. 6 depicts an example granularity for defining model pairs and their relations to sets of inference parameters, e.g., as an alternative to that illustrated by FIG. 5.

In contrast to FIG. 5, which includes one or more model pairs per set of inference parameters, FIG. 6 illustrates an example in which multiple sets of inference parameters are associated with one model pair, and multiple model pairs exist for an AI/ML functionality 602. For example, a model pair 604 includes a UE model part A1 paired with a NE model part B1 and corresponds to a first set of inference parameters X and a second set of inference parameters Y. The model pair 604 can be trained using set X and/or set Y. A model pair 606 includes a UE model part A2 paired with a NE model part B2, and is associated with the first set of inference parameters X, the second set of inference parameters Y, and a third set of inference parameters Z.

The block diagram 600 illustrates model pairs trained in a generalized manner, considering different inference configurations or sets of inference parameters. The different sets of inference parameters may dictate various factors of model pair performance, including accuracy, complexity, power consumption, and hardware requirements. Additionally, because there are different sets of inference parameters considered during training the training phase, the UE and the network both need to apply one of the sets of inference parameters that the model pair used during training when performing inference Additionally, an applicability of a model pair can vary for each set of inference parameters.

FIG. 7 illustrates an example process flow 700 in accordance with aspects of the present disclosure. In some examples, the process flow 700 implements or is implemented by aspects of the wireless communications system 100. For example, operations of the process flow 700 may be implemented by an UE 104 and an NE 102 as described with reference to FIG. 1. In this example, the UE 104 represents a node A (e.g., a first node) and the NE 102 represents a node B (e.g., a second node). The process flow 700 illustrates how the NE 102 and the UE 104 may coordinate to determine supported functionalities and establish appropriate model pairings for two-sided ML models. The examples described herein are not to be construed as limiting. For example, any network node may perform the operations of the process flow 700.

As described herein, “capability” refers to AI/ML functionalities and features that a network node (e.g., a UE) can support or execute, e.g., via implementation of an AI/ML model. A UE capability may encompass the AI/ML functionalities that the UE is equipped to handle, including models and/or model types it can store, execute, or participate in for inference operations. To facilitate model deployment and activation, the UE 104 and the NE 102 may exchange capability information. For instance, at 702, the NE 102 may transmit, and the UE 104 may receive, a capability inquiry requesting capability information from the UE 104, where the capability inquiry includes an inquiry for two-sided model capabilities. The capability inquiry may include or be an example of a capability request and, in some cases, may contain an identifier indicating a type of the NE 102. The capability inquiry may include or be an example of an RRC message.

At 704, in response to receiving the capability request, the UE 104 transmits, and the NE 102 receives, a capability report (e.g., UE-NR-Capability) indicating supported two-sided AI/ML models and/or functionalities. Alternatively, the UE 104 may proactively report this information to the NE 102. The capability report includes information including, but not limited to, indications of supported AI/ML functionalities, models, and/or model types, computational resources available for AI/ML operations, memory constraints, processing limitations, compatibility with indicated inference configurations or pairing identifiers, and the like. In some cases, the UE capability report includes an IE AIML-Parameters that indicates the supported two-sided AI/ML models and/or functionalities.

AI/ML functionality reported as UE capability indicates the functionalities/use cases supported by the UE 104, but not necessarily applicable at the UE 104. The UE 104 may not be able to apply all supported functionalities or models for inference at all times. Therefore, further coordination between the UE 104 and the NE 102 is needed to align on applicable functionalities and/or inference configurations. Capability may be distinguished from applicability in that capability indicates functionalities, models, or inference configurations that a node is capable of supporting, while applicability refers to whether a functionality, model, or inference configuration can be activated and applied for inference at a node, considering the current scenario, configuration, network-provided parameters, UE conditions, and network conditions.

In contrast to one-sided models where applicability determination can be performed independently at a single node, two-sided models require coordination between multiple nodes to ensure that compatible model parts are available and suitable for joint inference operations. The distributed nature of two-sided models means that even if a model part is available at one node, the corresponding paired model part may not be available or applicable at the other node. Additionally, the applicability of model parts may depend on conditions at both nodes. For example, a UE side model part may be inapplicable if UE battery levels are insufficient to support the computational complexity of the model, if the model requires hardware capabilities that are not available at the UE, or if the model part is unavailable at the UE (e.g., the UE does not have the model part downloaded).

Criteria for determining applicability of two-sided AI/ML models and/or functionalities include conditions and parameters for which the model parts were trained, as models are often optimized for particular scenarios, deployment sites, node conditions, and the like. A model part becomes inapplicable when current operating conditions do not match the training parameters or target scenarios for which it was configured. For instance, a cell-specific model part trained for a particular coverage area is inapplicable when the UE is located in a different cell. As another example, a model trained with indoor propagation characteristics is inapplicable for outdoor deployment scenarios. A node may determine an applicability of a model part, for example, based on compatibility between current operating parameters and training parameters (e.g., inference parameters) of the model part, by evaluating whether there is a match between a current deployment scenario and a target deployment scenario for which the model part was configured, or based on conditions at the node. Applicability is dynamic in nature and may change over time, as UE conditions, network conditions, or deployment scenarios evolve. For example, a UE may move to a different location, and a model part associated with the location may become applicable, while a model part associated with a previous location may become inapplicable.

The techniques described herein provide for signaling exchanged between nodes to request and indicate applicable functionalities and/or inference configurations for two-sided ML models. For example, at 706, the NE 102 transmits, and the UE 104 receives, an AI/ML applicability request indicating a request for the UE 104 to report applicable two-sided AI/ML models and/or functionalities. In some examples, the AI/ML applicability request may identify one or more specific functionalities, features, models, or inference configurations for which the NE 102 is requesting applicability information. Alternatively, the NE 102 may request any or all functionalities, features, models, or inference configurations that are applicable at the UE 104.

The AI/ML applicability request may include at least one pairing identifier associated with a model pair, indicating that the NE 102 is requesting applicability of a two-sided AI/ML model and/or functionality having a model part at the UE 104 and associated with the pairing identifier. Additionally, or alternatively, the AI/ML applicability request may include or otherwise indicate a data set and/or a set of parameters, based on which the UE determines whether and which two-sided AI/ML functionalities/models are applicable. Additionally, or alternatively, the AI/ML applicability request may include a set of inference parameters (e.g., CSI payload size, number of subbands, number of transmission ports) and one or more pairing identifiers. In some cases, the AI/ML applicability request includes an indication of an identifier of the inference parameters. In some cases, the identifier of the inference parameters is a pairing identifier. For instance, the set of inference parameters may be mapped to one or more pairing identifiers.

Upon receiving the AI/ML applicability request, the UE 104 determines a respective applicability status for one or more two-sided AI/ML models, model pairs, model parts, functionalities, and/or inference parameters. For example, the UE 104 may identify one or more pairing identifiers included in the AI/ML applicability request and determine which, if any, models, model pairs, model parts, functionalities, and/or inference parameters are associated with the indicated pairing identifier(s). The UE 104 may determine respective applicability statuses for each model, model pair, model part, functionality, and/or inference parameter associated with the pairing identifier(s).

The UE 104 may determine the applicability status(es) based on one or more UE conditions or one or more network conditions. As another example, when the AI/ML applicability request indicates a pairing identifier associated with a two-sided AI/ML model, the UE 104 may determine the applicability status(es) based on a corresponding set of inference parameters, an availability of a model part associated with the two-sided AI/ML model at the UE 104, deployment criteria associated with the two-sided AI/ML model, or one or more training parameters associated with the two-sided AI/ML model. When the AI/ML applicability request indicates a set of inference parameters, the UE 104 may determine which, if any, two-sided AI/ML models or model parts at the UE 104 are applicable (or inapplicable) for inference using the set of inference parameters. If the AI/ML applicability request does not include a pairing identifier, the UE 104 may determine an applicability status for any or all AI/ML functionalities/models at the UE 104.

Based on receiving the AI/ML applicability request, at 708, the UE 104 transmits, and the NE 102 receives, an AI/ML applicability report that indicates the determined applicability status(es) (e.g., applicable or inapplicable). For example, the AI/ML applicability report may indicate an applicability status of the models, model parts, model pairs, functionalities, and/or inference parameters associated with the pairing identifier(s) indicated in the AI/ML applicability request. The AI/ML applicability report may include or be an example of an RRC message, such as an RRCReconfigurationComplete message. Additionally, or alternatively, the AI/ML applicability report may indicate one or more sets of inference parameters mapped to the pairing identifier(s), as well as their corresponding applicability statuses.

In some cases, the UE 104 may include one or more parameters in the AI/ML applicability report such that the NE 102 may identify the type of models available at the UE 104 for the requested pairing identifier. In some examples, the AI/ML applicability report may include the applicability status of one or more AI/ML functionalities, configurations, or models/model parts configured at the UE 104. For instance, if the AI/ML applicability request does not include a pairing identifier or a set of parameters, the UE 104 may indicate, in the AI/ML applicability report, a list of all applicable and/or inapplicable AI/ML functionalities, configurations, or models/model parts at the UE 104 and their respective pairing identifiers. As another example, the AI/ML applicability report may indicate a respective applicability status and a respective pairing identifier for each two-sided ML model of a set of two-sided ML models configured at the UE 104. In some cases, the AI/ML applicability report may indicate a respective inapplicability cause for each AI/ML functionality, configuration, or model/model part indicated as inapplicable.

At 710, the NE 102 transmits, and the UE 104 receives, an inference configuration for one or more applicable two-sided AI/ML functionalities or models/model parts. The inference configuration includes a pairing identifier that indicates the AI/ML model/model part or functionality to which the inference configuration corresponds. The inference configuration may correspond to an AI/ML model/model part or functionality indicated in the capability report from the UE 104 and/or indicated in the AI/ML applicability report from the UE 104. The UE 104 may activate the AI/ML model/model part or functionality in response to receiving the inference configuration.

In some cases, the NE 102 may transmit the inference configuration in response to receiving the AI/ML applicability report. In some examples, the inference configuration includes or otherwise indicates one or more conditions for activation or deactivation of an AI/ML model/model part or functionality at the UE 104.

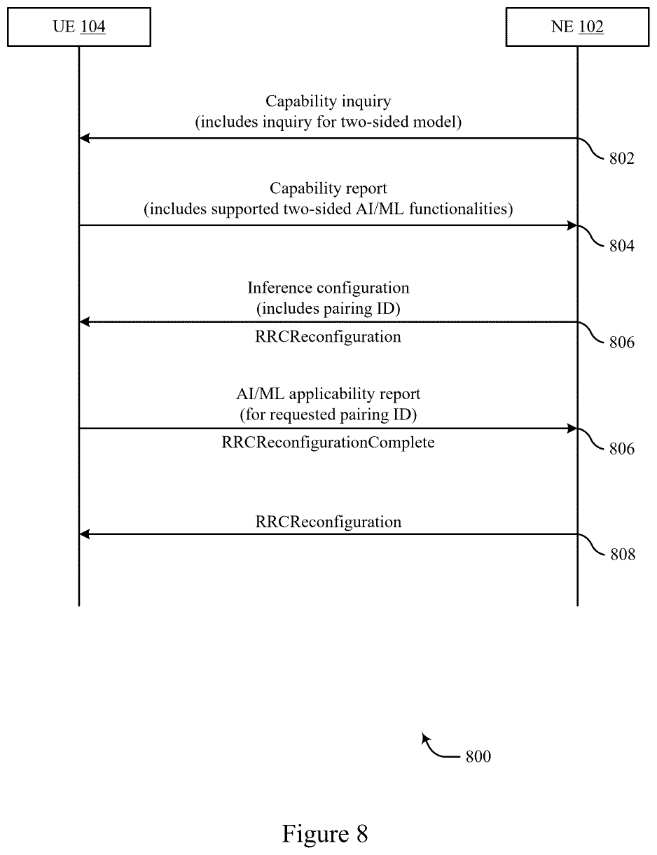

FIG. 8 illustrates an example process flow 800 in accordance with aspects of the present disclosure. In some examples, the process flow 800 implements or is implemented by aspects of the wireless communications system 100. For example, operations of the process flow 800 may be implemented by an UE 104 and an NE 102 as described with reference to FIG. 1. In this example, the UE 104 represents a node A (e.g., a first node) and the NE 102 represents a node B (e.g., a second node). The process flow 800 illustrates an example in which the NE 102 provides an inference configuration for a two-sided AI/ML model or functionality prior to receiving an AI/ML applicability report from the UE 104. The examples described herein are not to be construed as limiting. For example, any network node may perform the operations of the process flow 800.

At 802, the NE 102 may transmit, and the UE 104 may receive, a capability inquiry requesting capability information from the UE 104, where the capability inquiry includes an inquiry for two-sided AI/ML models and/or functionalities supported by the UE 104. The capability inquiry may include or be an example of a capability request and, in some cases, may contain an identifier indicating a type of the NE 102. The capability inquiry may include or be an example of an RRC message.

At 804, in response to receiving the capability request, the UE 104 transmits, and the NE 102 receives, a capability report (e.g., UE-NR-Capability) indicating supported two-sided AI/ML models and/or functionalities. Alternatively, the UE 104 may proactively report this information to the NE 102 (e.g., prior to receiving a capability request). The capability report includes information including, but not limited to, indications of supported AI/ML functionalities, models, and/or model types, computational resources available for AI/ML operations, memory constraints, processing limitations, compatibility with indicated inference configurations or pairing identifiers, and the like. In some cases, the UE capability report includes an IE AIML-Parameters that indicates the supported two-sided AI/ML models and/or functionalities. In some examples, the UE capability report includes a respective pairing identifier for each two-sided AI/ML model and/or functionality supported by the UE 104.

At 806, the NE 102 transmits, and the UE 104 receives, an inference configuration including one or more pairing identifiers. For example, the NE 102 may transmit the inference configuration in response to receiving the capability request. The inference configuration is for one or more two-sided AI/ML functionalities or models/model parts corresponding to the one or more pairing identifiers. In some cases, the NE 102 selects the inference configuration based on the inference configuration being associated with a pairing identifier indicated in the UE capability report, e.g., based on the pairing identifier corresponding to an AI/ML functionality or model/model part supported by the UE 104. Additionally, or alternatively, the NE 102 refrains from selecting an inference configuration associated with a pairing identifier that is not included in the UE capability report. That is, the NE 102 may only provide an inference configuration for an AI/ML functionality or model/model part supported by the UE 104.

Additionally, or alternatively, the NE 102 selects the inference configuration based on an applicability status of a model part at the NE 102, where the model part is associated with the inference configuration. For example, the NE 102 may determine one or more model parts that are applicable at the NE 102 and may select a corresponding inference configuration and pairing identifier for transmission to the UE 104. In some examples, the inference configuration includes or otherwise indicates one or more conditions for activation or deactivation of the AI/ML functionalities or models/model parts at the UE 104. The inference configuration may include or be an example of an RRC message, such as an RRCReconfiguration message.

The inference configuration may implicitly indicate a request for the UE 104 to report applicability statuses of the two-sided AI/ML functionalities or models/model parts associated with the one or more pairing identifiers. For example, in response to (e.g., based on) receiving the inference configuration, the UE 104 may determine applicability statuses of the two-sided AI/ML functionalities or models/model parts associated with the pairing identifier(s) included in the inference configuration. At 806, the UE 104 may transmit an AI/ML applicability report indicating the applicability statuses. The AI/ML applicability report may include or be an example of an RRC message, such as an RRCReconfigurationComplete message.

The NE 102 may reconfigure or deconfigure the UE 104 based on receiving the AI/ML applicability report. For example, the UE 104 may indicate, via the AI/ML applicability report, that the two-sided AI/ML functionality or model/model part associated with the inference configuration is inapplicable. In response, at 808, the NE 102 may transmit, and the UE 104 may receive, an RRCReconfiguration message that reconfigures or deconfigures the inference configuration.

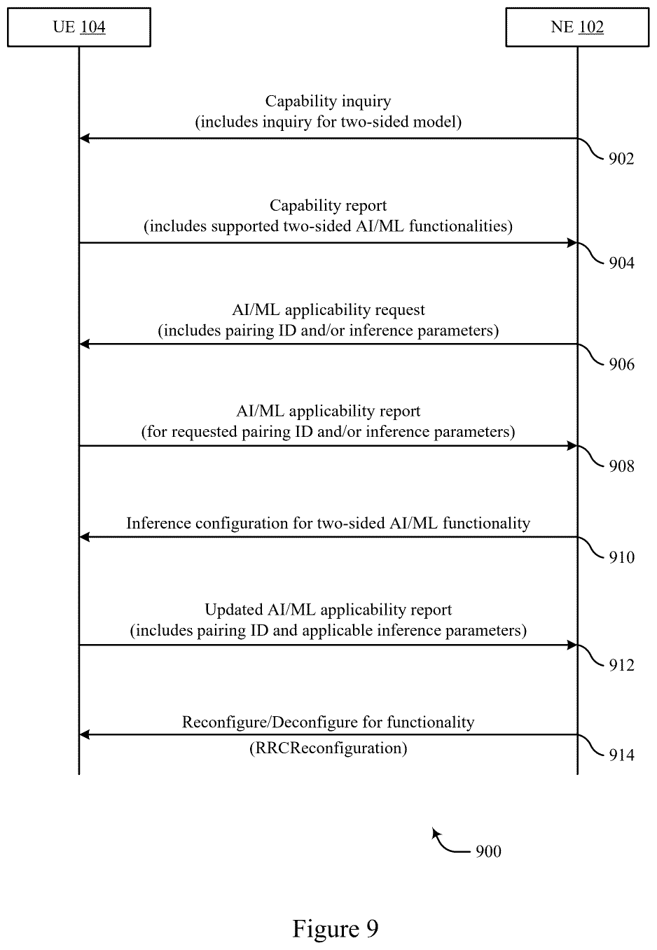

FIG. 9 illustrates an example process flow 900 in accordance with aspects of the present disclosure. In some examples, the process flow 900 implements or is implemented by aspects of the wireless communications system 100. For example, operations of the process flow 900 may be implemented by an UE 104 and an NE 102 as described with reference to FIG. 1. In this example, the UE 104 represents a node A (e.g., a first node) and the NE 102 represents a node B (e.g., a second node). The examples described herein are not to be construed as limiting. For example, any network node may perform the operations of the process flow 900.

Unlike one-sided models where applicability reporting at the AI/ML configuration level is sufficient, two-sided models require more granular reporting due to their distributed nature. For a single AI/ML configuration, there may be multiple pairs of models trained for inference based on varying UE-side or network-side conditions such as battery levels, hardware configurations, or computational complexity requirements. Additionally, a single model pair can be trained with multiple sets of different inference parameters as described with reference to FIG. 6, creating multiple operational modes for a same model. Thus, the process flow 900 illustrates an example in which the UE 104 and the NE 102 dynamically monitor and detect applicability status changes and initiate appropriate reconfiguration or deconfiguration actions.

At 902, the NE 102 may transmit, and the UE 104 may receive, a capability inquiry requesting capability information from the UE 104, where the capability inquiry includes an inquiry for two-sided AI/ML models and/or functionalities supported by the UE 104. The capability inquiry may include or be an example of a capability request and, in some cases, may contain an identifier indicating a type of the NE 102. The capability inquiry may include or be an example of an RRC message.

At 904, in response to receiving the capability request, the UE 104 transmits, and the NE 102 receives, a capability report (e.g., UE-NR-Capability) indicating supported two-sided AI/ML models and/or functionalities. Alternatively, the UE 104 may proactively report this information to the NE 102 (e.g., prior to receiving a capability request). The capability report includes information including, but not limited to, indications of supported AI/ML functionalities, models, and/or model types, computational resources available for AI/ML operations, memory constraints, processing limitations, compatibility with indicated inference configurations or pairing identifiers, and the like. In some cases, the UE capability report includes an IE AIML-Parameters that indicates the supported two-sided AI/ML models and/or functionalities.

At 906, the NE 102 transmits, and the UE 104 receives, an AI/ML applicability request as described with reference to FIGS. 7 and 8. The AI/ML applicability request may include at least one pairing identifier associated with a model pair and/or set of inference parameters, indicating that the NE 102 is requesting applicability of a two-sided AI/ML model and/or functionality having a model part at the UE 104 and associated with the pairing identifier.

At 908, the UE 104 transmits, and the NE 102 receives, an AI/ML applicability report indicating determined applicability status(es) (e.g., applicable or inapplicable) associated with the at least one pairing identifier. For example, the AI/ML applicability report may indicate an applicability status of the models, model parts, model pairs, functionalities, and/or inference parameters associated with the pairing identifier(s) indicated in the AI/ML applicability request. The AI/ML applicability report may include or be an example of an RRC message, such as an RRCReconfigurationComplete message or a message similar to UE Assistance Information (UAI).

At 910, the NE 102 transmits, and the UE 104 receives, an inference configuration including one or more pairing identifiers. For example, the NE 102 may transmit the inference configuration in response to receiving the AI/ML applicability report. The inference configuration is for one or more two-sided AI/ML functionalities or models/model parts corresponding to the one or more pairing identifiers. In some cases, the NE 102 selects the inference configuration based on the inference configuration being associated with a pairing identifier indicated in the AI/ML applicability report, e.g., based on the pairing identifier corresponding to an AI/ML functionality or model/model part indicated as applicable by the UE 104. Additionally, or alternatively, the NE 102 refrains from selecting an inference configuration associated with a pairing identifier that is not included in the AI/ML applicability report. That is, the NE 102 may only provide an inference configuration for an AI/ML functionality or model/model part that is applicable at the UE 104.

Additionally, or alternatively, the NE 102 selects the inference configuration based on an applicability status of a model part at the NE 102, where the model part is associated with the inference configuration. For example, the NE 102 may determine one or more model parts that are applicable at the NE 102 and may select a corresponding inference configuration and pairing identifier for transmission to the UE 104. In some examples, the inference configuration includes or otherwise indicates one or more conditions for activation or deactivation of the AI/ML functionalities or models/model parts at the UE 104. The inference configuration may include or be an example of an RRC message, such as an RRCReconfiguration message.

The UE 104 may activate a model part (e.g., corresponding to the AI/ML model/model part or functionality associated with the one or more pairing identifiers) in accordance with the inference configuration, e.g., in response to receiving the inference configuration. In some cases, the UE 104 may activate the model part in accordance with a MACCE or DCI. For example, the UE 104 may activate the model part in response to receiving a MAC-CE or DCI from the NE 102, where the MAC-CE or DCI includes an indication for the UE 104 to activate the model part. The UE 104 may monitor the applicability of the model part over time (e.g., periodically, semi-statically) to detect changes in applicability. If the model part becomes inapplicable, the UE 104 may transmit an updated AI/ML applicability report to the NE 102 to indicate the change in applicability.

For example, at 912, the UE 104 transmits, and the NE 102 receives, an updated AI/ML applicability report including the pairing identifier associated with the inapplicable model part. In some cases, the updated AI/ML applicability report additionally or alternatively indicates inference parameters associated with the pairing identifier and the inapplicable model part. Additionally, or alternatively, the UE 104 may monitor the applicability status of inapplicable AI/ML models/model parts or functionalities and may transmit the updated AI/ML applicability report if any become applicable. Here, the updated AI/ML applicability report includes the pairing identifiers corresponding to the now-applicable AI/ML models/model parts or functionalities. In either case, the updated AI/ML applicability report indicates applicability statuses associated with each pairing identifier.

The updated AI/ML applicability report may include or be an example of UE assistance information (UAI) signaling or an RRC message. In some cases, the applicability status report may include applicability status information for all model pairs configured by the NE 102, including model pairs from previous configurations. The updated AI/ML applicability report may indicate the applicability or inapplicability for the corresponding pairing identifier and/or for inference parameters relevant to the pairing identifiers. In some examples, the UE 104 may include, in the updated AI/ML applicability report, a preference or request for a pairing identifier to be configured.

Based on the updated AI/ML applicability report, the NE 102 may reconfigure or deconfigure the UE 104 to adjust configurations or deactivate models or functionalities that are no longer applicable. For example, at 914, the NE 102 transmits, and the UE 104 receives, an RRCReconfiguration message. The RRCReconfiguration message may indicate a pairing identifier for a model or functionality that the UE 104 is to deconfigure. Additionally, or alternatively, the RRCReconfiguration message may include an inference configuration and a pairing identifier for an applicable model or functionality to be configured at the UE 104.

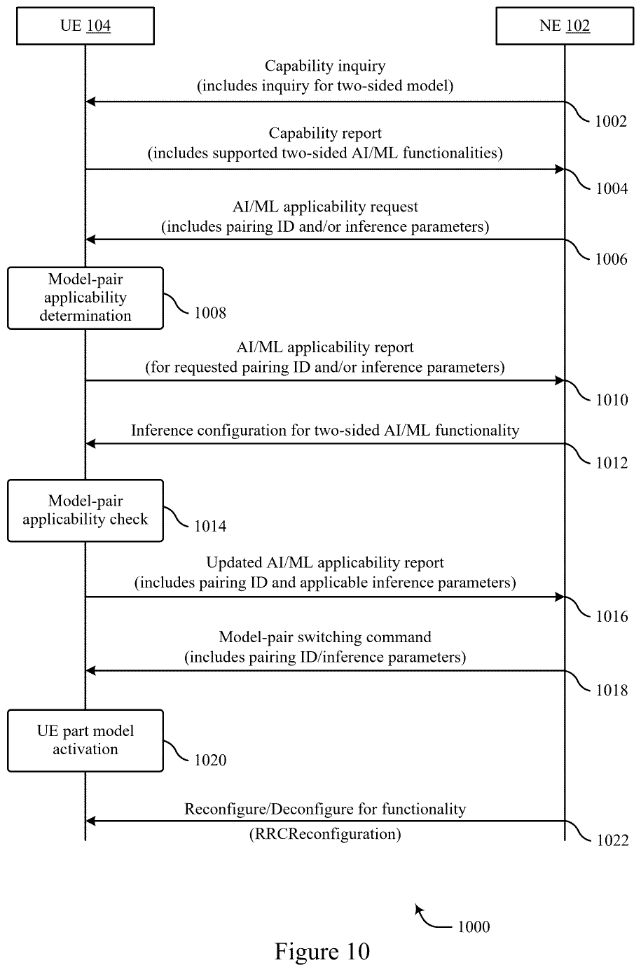

FIG. 10 illustrates an example process flow 1000 in accordance with aspects of the present disclosure. In some examples, the process flow 1000 implements or is implemented by aspects of the wireless communications system 100. For example, operations of the process flow 1000 may be implemented by an UE 104 and an NE 102 as described with reference to FIG. 1. The process flow 1000 illustrates a mechanism for the NE 102 to enable the UE 104 to switch from a first two-sided AI/ML model to a second two-sided AI/ML model. In this example, the UE 104 represents a node A (e.g., a first node) and the NE 102 represents a node B (e.g., a second node). The examples described herein are not to be construed as limiting. For example, any network node may perform the operations of the process flow 1000.

At 1002, the NE 102 may transmit, and the UE 104 may receive, a capability inquiry requesting capability information from the UE 104, where the capability inquiry includes an inquiry for two-sided AI/ML models and/or functionalities supported by the UE 104. The capability inquiry may include or be an example of a capability request and, in some cases, may contain an identifier indicating a type of the NE 102. The capability inquiry may include or be an example of an RRC message.

At 1004, in response to receiving the capability request, the UE 104 transmits, and the NE 102 receives, a capability report (e.g., UE-NR-Capability) indicating supported two-sided AI/ML models and/or functionalities. Alternatively, the UE 104 may proactively report this information to the NE 102 (e.g., prior to receiving a capability request). The capability report includes information including, but not limited to, indications of supported AI/ML functionalities, models, and/or model types, computational resources available for AI/ML operations, memory constraints, processing limitations, compatibility with indicated inference configurations or pairing identifiers, and the like. In some cases, the UE capability report includes an IE AIML-Parameters that indicates the supported two-sided AI/ML models and/or functionalities.

At 1006, the NE 102 transmits, and the UE 104 receives, an AI/ML applicability request as described with reference to FIGS. 7-9. The AI/ML applicability request may include at least one pairing identifier associated with a model pair and/or set of inference parameters, indicating that the NE 102 is requesting applicability of a two-sided AI/ML model and/or functionality having a model part at the UE 104 and associated with the pairing identifier.

At 1008, the UE 104 determines a respective applicability status for one or more two-sided AI/ML models, model pairs, model parts, functionalities, and/or inference parameters. For example, the UE 104 may identify one or more pairing identifiers included in the AI/ML applicability request and determine which, if any, models, model pairs, model parts, functionalities, and/or inference parameters are associated with the indicated pairing identifier(s). The UE 104 may determine respective applicability statuses for each model, model pair, model part, functionality, and/or inference parameter associated with the pairing identifier(s).

The UE 104 may determine the applicability status(es) based on one or more UE conditions or one or more network conditions. As another example, when the AI/ML applicability request indicates a pairing identifier associated with a two-sided AI/ML model, the UE 104 may determine the applicability status(es) based on a corresponding set of inference parameters, an availability of a model part associated with the two-sided AI/ML model at the UE 104, deployment criteria associated with the two-sided AI/ML model, or one or more training parameters associated with the two-sided AI/ML model. When the AI/ML applicability request indicates a set of inference parameters, the UE 104 may determine which, if any, two-sided AI/ML models or model parts at the UE 104 are applicable (or inapplicable) for inference using the set of inference parameters. If the AI/ML applicability request does not include a pairing identifier, the UE 104 may determine an applicability status for any or all AI/ML functionalities/models at the UE 104.

At 1010, the UE 104 transmits, and the NE 102 receives, an AI/ML applicability report that indicates the determined applicability status(es) (e.g., applicable or inapplicable) as described with reference to FIGS. 7-9. For example, the AI/ML applicability report may indicate an applicability status of the models, model parts, model pairs, functionalities, and/or inference parameters associated with the pairing identifier(s) indicated in the AI/ML applicability request. The AI/ML applicability report may include or be an example of an RRC message, such as an RRCReconfigurationComplete message. Additionally, or alternatively, the AI/ML applicability report may indicate one or more sets of inference parameters mapped to the pairing identifier(s), as well as their corresponding applicability statuses.

In some cases, the UE 104 may include one or more parameters in the AI/ML applicability report such that the NE 102 may identify the type of models available at the UE 104 for the requested pairing identifier. In some examples, the AI/ML applicability report may include the applicability status of one or more AI/ML functionalities, configurations, or models/model parts configured at the UE 104. For instance, if the AI/ML applicability request does not include a pairing identifier or a set of parameters, the UE 104 may indicate, in the AI/ML applicability report, a list of all applicable and/or inapplicable AI/ML functionalities, configurations, or models/model parts at the UE 104 and their respective pairing identifiers. As another example, the AI/ML applicability report may indicate a respective applicability status and a respective pairing identifier for each two-sided ML model of a set of two-sided ML models configured at the UE 104. In some cases, the AI/ML applicability report may indicate a respective inapplicability cause for each AI/ML functionality, configuration, or model/model part indicated as inapplicable.

At 1012, the NE 102 transmits, and the UE 104 receives, an inference configuration for one or more applicable two-sided AI/ML functionalities or models/model parts. The inference configuration includes a pairing identifier that indicates the AI/ML model/model part or functionality to which the inference configuration corresponds. The inference configuration may correspond to an AI/ML model/model part or functionality indicated in the capability report from the UE 104 and/or indicated in the AI/ML applicability report from the UE 104. The UE 104 may activate the AI/ML model/model part or functionality in response to receiving the inference configuration. Additionally, or alternatively, the UE 104 may activate the model part in accordance with a MAC-CE or DCI. For example, the UE 104 may activate the model part in response to receiving a MAC-CE or DCI from the NE 102, where the MAC-CE or DCI includes an indication for the UE 104 to activate the model part. In some cases, the NE 102 may transmit the inference configuration in response to receiving the AI/ML applicability report. In some examples, the inference configuration includes or otherwise indicates one or more conditions for activation or deactivation of an AI/ML model/model part or functionality at the UE 104.

The UE 104 may monitor the applicability status of configured AI/ML functionalities or models/model parts over time (e.g., periodically, semi-statically) to detect changes in applicability, such as by monitoring operational conditions that may affect model performance or availability. At 1014, the UE 104 performs a model pair applicability check and may determine that an active or applicable AI/ML model/model part or functionality has become inapplicable, or that a previously inapplicable AI/ML model/model part or functionality has become applicable and/or available for activation. If another AI/ML model/model part or functionality for the same inference configuration exists, the UE 104 can switch to the other AI/ML model/model part or functionality without performing a complete RRC reconfiguration procedure. In scenarios where the UE 104 switches between model parts that are associated with the same pairing identifier, the UE 104 may or may not indicate the switch to the NE 102.

For example, at 1014, the UE 104 may detect that a model part has become inapplicable. Based on the detection, at 1016, the UE 104 transmits, and the NE 102 receives, an updated AI/ML applicability report including the corresponding pairing identifier and any applicable inference parameters. The updated AI/ML applicability report may indicate an applicability of the model part. In some cases, the updated AI/ML applicability report indicates a pairing identifier preferred by the UE 104 for subsequent configuration.

In response to the updated AI/ML applicability report, at 1018, the NE 102 transmits, and the UE 104 receives, a model pair switching command that includes a pairing identifier associated with a model part to be activated at the UE 104. Alternatively, the NE 102 may proactively transmit the model pair switching command without receiving an applicability status report. The model pair switching command may include or be an example of a MAC-CE, DCI, or an RRC message. The model pair switching command indicates a pairing identifier for a new model pair to be applied and activated at the UE 104. The pairing identifier may be associated with an inference configuration that the UE 104 is already configured with. If the UE 104 indicated a pairing identifier associated with a model part to which the UE 104 prefers to switch, the NE 102 may transmit the model switching command in response to the indicated preference while indicating whether the NE 102 approves the switch. Alternatively, the UE 104 may indicate only inapplicable pairing identifiers in the updated AI/ML applicability report, such that the NE 102 responds with a model switching command indicating a different pairing identifier to which the UE 104 should switch. In some cases, the pairing identifier may be associated with an inference configuration that already exists at the UE 104. The pairing identifier may include a configuration identifier of the inference configuration associated with the model pair.

Additionally, or alternatively, the model pair switching command may include multiple pairing identifiers with corresponding activation/deactivation indications, or can include switching conditions and rules for autonomous operation by the UE 104. For example, the model pair switching command may include one or more pairing identifiers corresponding to one or more activation conditions for activating or deactivating the corresponding model part. If the UE 104 detects that an activation condition is met, the UE 104 may switch to or away from the corresponding model part.

At 1020, the UE 104 may activate the model part associated with the pairing identifier indicated in the model pair switching command.

For cases when the change in model pair requires a change in network configuration, at 1022, the NE 102 sends an RRC message to reconfigure or deconfigure the corresponding model part. In some cases, the NE 102 may provide one or more inference configurations in advance, such that the UE 104 can switch from one configuration to another. For example, the UE 104 may switch from one configuration to another in response to or otherwise based on receiving a message from the NE 102. As another example, the UE 104 may be configured to report, to the NE 102, a preference to switch configurations (e.g., including configuration identifier(s), model pair identifiers, or the like). In response to the preference indication, the NE 102 may transmit, to the UE 104, a confirmation indication that indicates approval, after which the UE 104 may perform the switch.

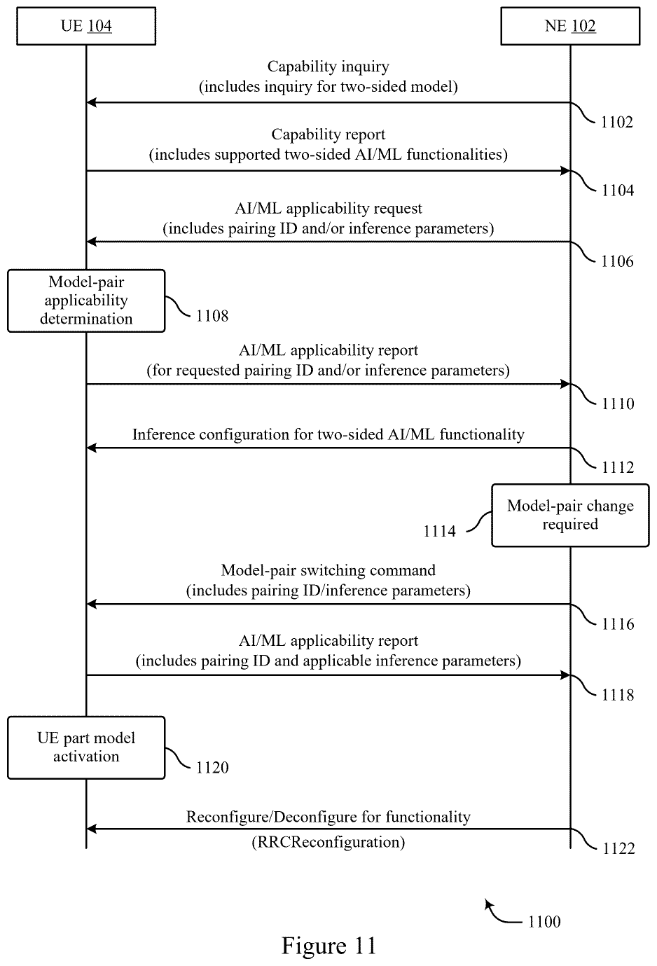

FIG. 11 illustrates an example process flow 1100 in accordance with aspects of the present disclosure. In some examples, the process flow 1100 implements or is implemented by aspects of the wireless communications system 100. For example, operations of the process flow 1100 may be implemented by an UE 104 and an NE 102 as described with reference to FIG. 1. The process flow 1100 illustrates a mechanism for the NE 102 to initiate a model pair switching process. In this example, the UE 104 represents a node A (e.g., a first node) and the NE 102 represents a node B (e.g., a second node). The examples described herein are not to be construed as limiting. For example, any network node may perform the operations of the process flow 1100.

At 1102, the NE 102 may transmit, and the UE 104 may receive, a capability inquiry requesting capability information from the UE 104, where the capability inquiry includes an inquiry for two-sided AI/ML models and/or functionalities supported by the UE 104. The capability inquiry may include or be an example of a capability request and, in some cases, may contain an identifier indicating a type of the NE 102. The capability inquiry may include or be an example of an RRC message.

At 1104, in response to receiving the capability request, the UE 104 transmits, and the NE 102 receives, a capability report (e.g., UE-NR-Capability) indicating supported two-sided AI/ML models and/or functionalities. Alternatively, the UE 104 may proactively report this information to the NE 102 (e.g., prior to receiving a capability request). The capability report includes information including, but not limited to, indications of supported AI/ML functionalities, models, and/or model types, computational resources available for AI/ML operations, memory constraints, processing limitations, compatibility with indicated inference configurations or pairing identifiers, and the like. In some cases, the UE capability report includes an IE AIML-Parameters that indicates the supported two-sided AI/ML models and/or functionalities.

At 1106, the NE 102 transmits, and the UE 104 receives, an AI/ML applicability request as described with reference to FIGS. 7-10. The AI/ML applicability request may include at least one pairing identifier associated with a model pair and/or set of inference parameters, indicating that the NE 102 is requesting applicability of a two-sided AI/ML model and/or functionality having a model part at the UE 104 and associated with the pairing identifier.

At 1108, the UE 104 determines a respective applicability status for one or more two-sided AI/ML models, model pairs, model parts, functionalities, and/or inference parameters. For example, the UE 104 may identify one or more pairing identifiers included in the AI/ML applicability request and determine which, if any, models, model pairs, model parts, functionalities, and/or inference parameters are associated with the indicated pairing identifier(s). The UE 104 may determine respective applicability statuses for each model, model pair, model part, functionality, and/or inference parameter associated with the pairing identifier(s).

The UE 104 may determine the applicability status(es) based on one or more UE conditions or one or more network conditions. As another example, when the AI/ML applicability request indicates a pairing identifier associated with a two-sided AI/ML model, the UE 104 may determine the applicability status(es) based on a corresponding set of inference parameters, an availability of a model part associated with the two-sided AI/ML model at the UE 104, deployment criteria associated with the two-sided AI/ML model, or one or more training parameters associated with the two-sided AI/ML model. When the AI/ML applicability request indicates a set of inference parameters, the UE 104 may determine which, if any, two-sided AI/ML models or model parts at the UE 104 are applicable (or inapplicable) for inference using the set of inference parameters. If the AI/ML applicability request does not include a pairing identifier, the UE 104 may determine an applicability status for any or all AI/ML functionalities/models at the UE 104.

At 1110, the UE 104 transmits, and the NE 102 receives, an AI/ML applicability report that indicates the determined applicability status(es) (e.g., applicable or inapplicable) as described with reference to FIGS. 7-10. For example, the AI/ML applicability report may indicate an applicability status of the models, model parts, model pairs, functionalities, and/or inference parameters associated with the pairing identifier(s) indicated in the AI/ML applicability request. The AI/ML applicability report may include or be an example of an RRC message, such as an RRCReconfigurationComplete message. Additionally, or alternatively, the AI/ML applicability report may indicate one or more sets of inference parameters mapped to the pairing identifier(s), as well as their corresponding applicability statuses.

In some cases, the UE 104 may include one or more parameters in the AI/ML applicability report such that the NE 102 may identify the type of models available at the UE 104 for the requested pairing identifier. In some examples, the AI/ML applicability report may include the applicability status of one or more AI/ML functionalities, configurations, or models/model parts configured at the UE 104. For instance, if the AI/ML applicability request does not include a pairing identifier or a set of parameters, the UE 104 may indicate, in the AI/ML applicability report, a list of all applicable and/or inapplicable AI/ML functionalities, configurations, or models/model parts at the UE 104 and their respective pairing identifiers. As another example, the AI/ML applicability report may indicate a respective applicability status and a respective pairing identifier for each two-sided ML model of a set of two-sided ML models configured at the UE 104. In some cases, the AI/ML applicability report may indicate a respective inapplicability cause for each AI/ML functionality, configuration, or model/model part indicated as inapplicable.

At 1112, the NE 102 transmits, and the UE 104 receives, an inference configuration for one or more applicable two-sided AI/ML functionalities or models/model parts. The inference configuration includes a pairing identifier that indicates the AI/ML model/model part or functionality to which the inference configuration corresponds. The inference configuration may correspond to an AI/ML model/model part or functionality indicated in the capability report from the UE 104 and/or indicated in the AI/ML applicability report from the UE 104. The UE 104 may activate the AI/ML model/model part or functionality in response to receiving the inference configuration. In some cases, the NE 102 may transmit the inference configuration in response to receiving the AI/ML applicability report. In some examples, the inference configuration includes or otherwise indicates one or more conditions for activation or deactivation of an AI/ML model/model part or functionality at the UE 104.

The NE 102 may monitor the applicability status of configured AI/ML functionalities or models/model parts over time (e.g., periodically, semi-statically) to detect changes in applicability, such as by monitoring operational conditions that may affect model performance or availability. At 1114, the NE 102 determines or otherwise detects that a model pair change is required, e.g., based on associated inference parameters, an availability of an active model part at the NE 102, one or more network conditions, or the like. For example, the NE 102 may detect that a model part active at the NE 102 is no longer applicable, and thus both the model part at the NE 102 and the corresponding model part active at the UE 104 need to change. The NE 102 may select a different model/model part to switch to, e.g., based on a corresponding applicability status, set of inference parameters, or the like. In some cases, the NE 102 may initiate model switching based on internal processing requirements, complexity considerations, or performance optimization needs without requiring prior indication of inapplicability from the UE 104 (e.g., via an updated AI/ML applicability report).

At 1116, the NE 102 transmits, and the UE 104 receives, a model pair switching command that includes a pairing identifier associated with a model part to be activated at the UE 104 and/or a set of inference parameters associated with a model part at the UE 104. The model pair switching command can indicate switching from one model pair to another model pair based on their pairing identifier(s), or, alternatively the pairing identifier may remain consistent while the model pair is changed based on the set of inference parameters used for training the model pair. The model pair switching command may include or be an example of a MAC-CE, DCI, or an RRC message. In some cases, the pairing identifier may be associated with an inference configuration that already exists at the UE 104.

In some examples, when the NE 102 initiates the model switching, it may wait to receive an AI/ML applicability report from the UE 104 before activating the new model/model part. For example, at 1118, the UE 104 may transmit an AI/ML applicability report in response to receiving the model pair switching command. The AI/ML applicability report may indicate an applicability status of a model part at the UE 104 corresponding to the pairing identifier indicated in the model pair switching command. In another example, the AI/ML applicability report is optional depending on the new pairing identifier and previous applicability reports. For instance, if the UE 104 has previously indicated that the model part associated with the new pairing identifier is applicable, the UE 104 may activate the model part upon receiving the model switching command, e.g., at 1120.

At 1120, the UE 104 may activate the model part indicated in the model switching command.

When the network-initiated model pair change requires updates to the network configuration, the NE 102 may transmit, at 1122, an RRCReconfiguration message to the UE 104 to reconfigure or deconfigure the corresponding model part.

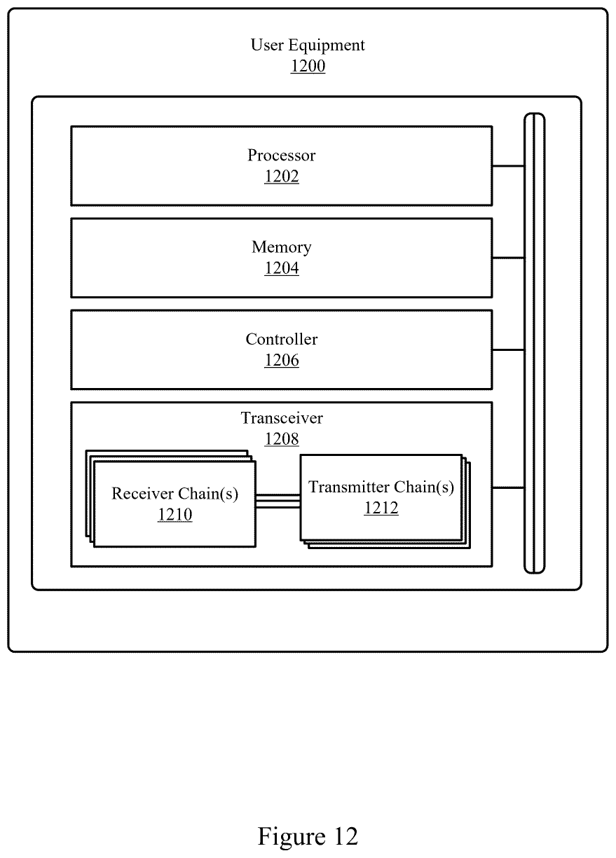

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a central processing unit (CPU), an ASIC, a field-programmable gate-array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving an identifier for pairing at least two model parts associated with a two-sided ML model, where the two-sided ML model includes a first model part configured for execution at the UE and a second model part configured for execution at a network node, where the identifier identifies whether the first model part is paired with the second model part, determining a status of the first model part based on the identifier associated with the first model part, where the status is indicative of an applicability of the first model part for inference at the UE, and transmitting a report that indicates the status of the first model part, where the report includes the identifier. In this manner, the UE 1200 supports coordinated model selection between network nodes and prevents incompatible model part activation that would degrade inference performance or cause operational failures.

Additionally, the UE 1200 may be configured to support any one or combination of the status is determined based on at least one of a set of inference parameters, an availability of the first model part at the UE 1200, one or more UE conditions, one or more network conditions, one or more deployment criteria associated with the two-sided ML model, or one or more training parameters associated with the two-sided ML model. This aspect ensures that model parts are only activated when operating conditions match their design parameters, improving inference accuracy and preventing system failures at the UE 1200.

Additionally, or alternatively, the UE 1200 may be configured to support receiving an inference configuration for the two-sided ML model based on the report, where the inference configuration includes the identifier and a set of inference parameters. This aspect reduces signaling overhead by avoiding configuration of inapplicable models and ensuring proper model coordination.

Additionally, or alternatively, the UE 1200 may be configured to support activating the first model part in response to receiving the inference configuration and based on the status of the first model part being applicable. This aspect ensures synchronized model deployment across both network nodes, preventing mismatched model part operation that would produce erroneous inference results.

Additionally, or alternatively, the inference configuration indicates one or more conditions for activation or deactivation of the first model part at the UE. This aspect enables autonomous model management at the UE 1200 based on predefined criteria, reducing signaling overhead and improving efficiency by improving response time to changing operational conditions.

Additionally, or alternatively, the report further indicates one or more of a respective status and a respective identifier for each two-sided learning model of a set of two-sided ML models configured at the UE, or at least one set of inference parameters associated with the identifier. This aspect enables efficient coordination of model pairs at granular levels, reducing the number of individual signaling exchanges required for two-sided model deployments.

Additionally, or alternatively, the UE 1200 may be configured to support transmitting, in response to a capability request, a capability report indicating a set of machine learning model functionalities supported by the UE, where the identifier is received as part of an inference configuration in response to the capability report, where the inference configuration corresponds to a machine learning model functionality of the set of machine learning model functionalities. This aspect ensures that only compatible and supported models are configured, preventing resource waste and configuration failures and improving communications reliability, efficiency, and performance.

Additionally, or alternatively, the UE 1200 may be configured to support detecting a change in the status of the first model part and transmitting an updated report indicating the change in the status, where the updated report includes the identifier. This aspect enables dynamic adaptation to varying operational conditions, maintaining optimal model performance as UE conditions, network conditions, or deployment scenarios evolve over time.

Additionally, or alternatively, the UE 1200 may be configured to support receiving a model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers, and determining a status of at least one model part corresponding to at least one identifier of the one or more identifiers. This aspect enables efficient model transitions without full reconfiguration procedures, reducing signaling overhead while maintaining coordination between paired model parts.

Additionally, or alternatively, the model switching command is received in response to the report or an updated report. This aspect enables reactive model management based on actual UE conditions, ensuring timely transitions when active models become inapplicable or better alternatives become available.

Additionally, or alternatively, the UE 1200 may be configured to support transmitting a request to switch to a model part, the request including an identifier associated with the model part. This aspect enables UE-initiated model optimization based on local conditions, improving system responsiveness and allowing proactive model selection for optimal performance.

Additionally, or alternatively, the identifier is associated with a dataset used to train the two-sided ML model. This aspect ensures that model parts trained on compatible data are properly paired during inference at the UE 1200, maintaining consistency between training and deployment phases for accurate inference results.

Additionally, or alternatively, the UE 1200 may support at least one memory (e.g., the memory 1204) and at least one processor (e.g., the processor 1202) coupled with the at least one memory and configured to cause the UE 1200 to receive an identifier for pairing at least two model parts associated with a two-sided ML model, where the two-sided ML model includes a first model part configured for execution at the UE 1200 and a second model part configured for execution at a network node, where the identifier identifies whether the first model part is paired with the second model part, determine a status of the first model part based on the identifier associated with the first model part, where the status is indicative of an applicability of the first model part for inference at the UE 1200, and transmit a report that indicates the status of the first model part, where the report includes the identifier. In this manner, the UE 1200 supports coordinated model selection between network nodes and prevents incompatible model part activation that would degrade inference performance or cause operational failures.

Additionally, the UE 1200 may be configured to support any one or combination of the status is determined based on at least one of a set of inference parameters, an availability of the first model part at the UE 1200, one or more UE conditions, one or more network conditions, one or more deployment criteria associated with the two-sided ML model, or one or more training parameters associated with the two-sided ML model. This aspect ensures that model parts are only activated when operating conditions match their design parameters, improving inference accuracy and preventing system failures at the UE 1200.

Additionally, or alternatively, the UE 1200 may be configured to receive an inference configuration for the two-sided ML model based on the report, where the inference configuration includes the identifier and a set of inference parameters. This aspect reduces signaling overhead by avoiding configuration of inapplicable models and ensuring proper model coordination.

Additionally, or alternatively, the UE 1200 may be configured to activate the first model part in response to receiving the inference configuration and based on the status of the first model part being applicable. This aspect ensures synchronized model deployment across both network nodes, preventing mismatched model part operation that would produce erroneous inference results.

Additionally, or alternatively, the inference configuration indicates one or more conditions for activation or deactivation of the first model part at the UE. This aspect enables autonomous model management at the UE 1200 based on predefined criteria, reducing signaling overhead and improving response time to changing operational conditions.

Additionally, or alternatively, the report further indicates one or more of a respective status and a respective identifier for each two-sided learning model of a set of two-sided ML models configured at the UE, or at least one set of inference parameters associated with the identifier. This aspect enables efficient coordination of model pairs at granular levels, reducing the number of individual signaling exchanges required for multi-model deployments.

Additionally, or alternatively, the UE 1200 may be configured to transmit, in response to a capability request, a capability report indicating a set of machine learning model functionalities supported by the UE, where the identifier is received as part of an inference configuration in response to the capability report, and where the inference configuration corresponds to a machine learning model functionality of the set of machine learning model functionalities. This aspect ensures that only compatible and supported models are configured, preventing resource waste and configuration failures while enabling proper capability-based model selection.

Additionally, or alternatively, the UE 1200 may be configured to detect a change in the status of the first model part and transmit an updated report indicating the change in the status, where the updated report includes the identifier. This aspect enables dynamic adaptation to varying operational conditions, maintaining optimal model performance as UE conditions, network conditions, or deployment scenarios evolve over time.

Additionally, or alternatively, the UE 1200 may be configured to receive a model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers, and determine a status of at least one model part corresponding to at least one identifier of the one or more identifiers. This aspect enables efficient model transitions without full reconfiguration procedures, reducing signaling overhead while maintaining coordination between paired model parts.

Additionally, or alternatively, the model switching command is received in response to the report or an updated report. This aspect enables reactive model management based on actual UE conditions, ensuring timely transitions when active models become inapplicable or better alternatives become available.

Additionally, or alternatively, the UE 1200 may be configured to transmit a request to switch to a model part, the request including an identifier associated with the model part. This aspect enables UE-initiated model optimization based on local conditions, improving system responsiveness and allowing proactive model selection for optimal performance.

Additionally, or alternatively, the identifier is associated with a dataset used to train the two-sided ML model. This aspect ensures that model parts trained on compatible data are properly paired during inference at the UE 1200, maintaining consistency between training and deployment phases for accurate inference results.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

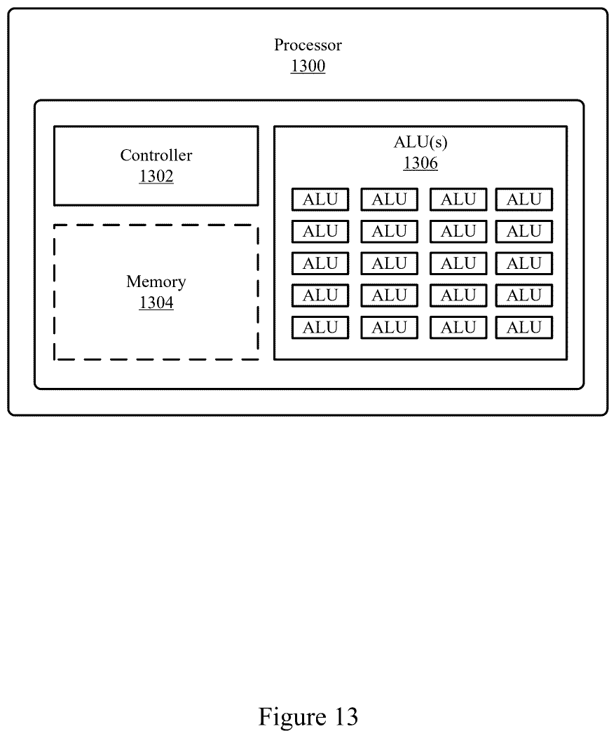

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive an identifier for pairing at least two model parts associated with a two-sided ML model, where the two-sided ML model includes a first model part configured for execution at the processor 1300 and a second model part configured for execution at a network node, where the identifier identifies whether the first model part is paired with the second model part, determine a status of the first model part based on the identifier associated with the first model part, where the status is indicative of an applicability of the first model part for inference at the processor 1300, and transmit a report that indicates the status of the first model part, where the report includes the identifier. In this manner, the processor 1300 supports coordinated model selection between network nodes and prevents incompatible model part activation that would degrade inference performance or cause operational failures.

Additionally, the processor 1300 may be configured to support any one or combination of the status is determined based on at least one of a set of inference parameters, an availability of the first model part at the processor 1300, one or more processor 1300 conditions, one or more network conditions, one or more deployment criteria associated with the two-sided ML model, or one or more training parameters associated with the two-sided ML model. This aspect ensures that model parts are only activated when operating conditions match their design parameters, improving inference accuracy and preventing system failures.

Additionally, or alternatively, the processor 1300 may be configured to receive an inference configuration for the two-sided ML model based on the report, where the inference configuration includes the identifier and a set of inference parameters. This aspect reduces signaling overhead by avoiding configuration of inapplicable models and ensuring proper model coordination.

Additionally, or alternatively, the processor 1300 may be configured to activate the first model part in response to receiving the inference configuration and based on the status of the first model part being applicable. This aspect ensures synchronized model deployment across both network nodes, preventing mismatched model part operation that would produce erroneous inference results.

Additionally, or alternatively, the inference configuration indicates one or more conditions for activation or deactivation of the first model part at the processor 1300. This aspect enables autonomous model management at the processor 1300 based on predefined criteria, reducing signaling overhead and improving efficiency by improving response time to changing operational conditions.

Additionally, or alternatively, the report further indicates one or more of a respective status and a respective identifier for each two-sided learning model of a set of two-sided ML models configured at the processor 1300, or at least one set of inference parameters associated with the identifier. This aspect enables efficient coordination of model pairs at granular levels, reducing the number of individual signaling exchanges required for two-sided model deployments.

Additionally, or alternatively, the processor 1300 may be configured to transmit, in response to a capability request, a capability report indicating a set of machine learning model functionalities supported by the processor 1300, where the identifier is received as part of an inference configuration in response to the capability report, and where the inference configuration corresponds to a machine learning model functionality of the set of machine learning model functionalities. This aspect ensures that only compatible and supported models are configured, preventing resource waste and configuration failures and improving communications reliability, efficiency, and performance.

Additionally, or alternatively, the processor 1300 may be configured to detect a change in the status of the first model part and transmit an updated report indicating the change in the status, where the updated report includes the identifier. This aspect enables dynamic adaptation to varying operational conditions, maintaining optimal model performance as UE conditions, network conditions, or deployment scenarios evolve over time.

Additionally, or alternatively, the processor 1300 may be configured to receive a model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers, and determine a status of at least one model part corresponding to at least one identifier of the one or more identifiers. This aspect enables efficient model transitions without full reconfiguration procedures, reducing signaling overhead while maintaining coordination between paired model parts.

Additionally, or alternatively, the model switching command is received in response to the report or an updated report. This aspect enables reactive model management based on actual UE conditions, ensuring timely transitions when active models become inapplicable or better alternatives become available.

Additionally, or alternatively, the processor 1300 may be configured to transmit a request to switch to a model part, the request including an identifier associated with the model part. This aspect enables model optimization based on local conditions, improving system responsiveness and allowing proactive model selection for optimal performance.

Additionally, or alternatively, the identifier is associated with a dataset used to train the two-sided ML model. This aspect ensures that model parts trained on compatible data are properly paired during inference, maintaining consistency between training and deployment phases for accurate inference results.

The processor 1300 may be configured to or operable to support at least one controller (e.g., the controller 1302) coupled with at least one memory (e.g., the memory 1304) and configured to cause the processor to transmit, to a UE, an identifier for pairing at least two model parts associated with a two-sided ML model, where the two-sided ML model includes a first model part configured for execution at the UE and a second model part configured for execution at the processor 1300, where the identifier identifies whether the first model part is paired with the second model part, and receive, from the UE, a report that indicates a status of the first model part corresponding to the identifier, where the report includes the identifier, and where the status is indicative of an applicability of the first model part for inference at the UE. In this manner, the processor 1300 supports informed model activation decisions that ensure compatible model parts are deployed together for accurate two-sided inference operations.

Additionally, the processor 1300 may be configured to support any one or combination of to transmit, to the UE, an inference configuration for the two-sided ML model, where the inference configuration includes the identifier and a set of inference parameters. This aspect enables coordinated model deployment with specific operational settings, ensuring both sides of the model pair operate with consistent parameters for optimal inference performance.

Additionally, or alternatively, the processor 1300 may be configured to select the identifier based on a status of the second model part at the processor 1300, where the status is indicative of an applicability of the second model part for inference at the processor 1300. This aspect ensures that only model pairs with applicable components on both sides are activated, preventing partial deployments that would result in inference failures or degraded performance.

Additionally, or alternatively, the identifier is transmitted as part of a request for the report. This aspect enables targeted status inquiries for specific model pairs, reducing signaling overhead by focusing coordination efforts on relevant models rather than broad capability exchanges.

Additionally, or alternatively, the processor 1300 may be configured to receive, from the UE, an updated report indicating a change in the status of the first model part, where the updated report includes the identifier. This aspect enables dynamic model management in response to evolving conditions, allowing the network to maintain optimal model deployments as operational circumstances change across the system.

Additionally, or alternatively, the processor 1300 may be configured to transmit a model switching command in response to receiving the report, the model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers. This aspect enables efficient model transitions based on actual UE conditions, providing rapid response to applicability changes without requiring full reconfiguration procedures.

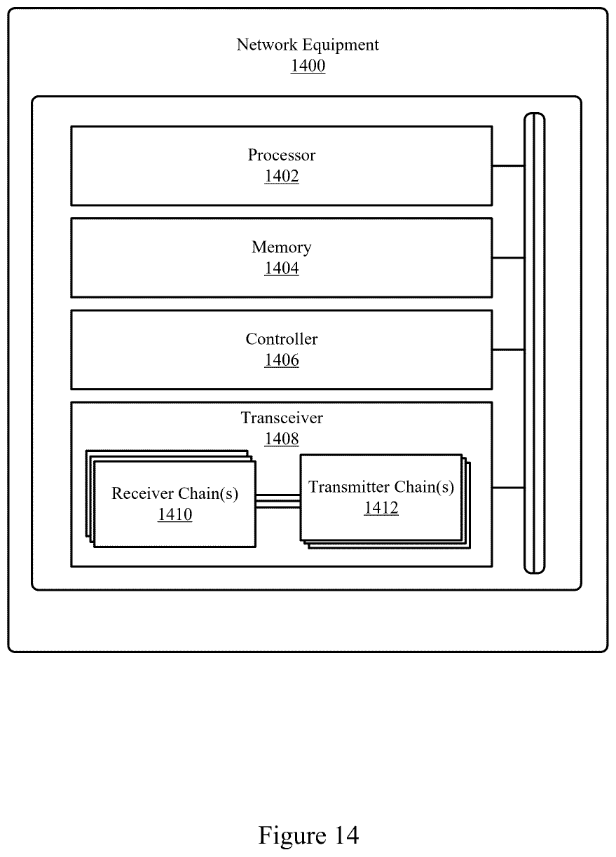

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting, to a UE, an identifier for pairing at least two model parts associated with a two-sided ML model, where the two-sided ML model includes a first model part configured for execution at the UE and a second model part configured for execution at the NE 1400, where the identifier identifies whether the first model part is paired with the second model part, and receiving, from the UE, a report that indicates a status of the first model part corresponding to the identifier, where the report includes the identifier, and where the status is indicative of an applicability of the first model part for inference at the UE. In this manner, the NE 1400 supports informed model activation decisions that ensure compatible model parts are deployed together for accurate two-sided inference operations.

Additionally, the NE 1400 may be configured to support any one or combination of transmitting, to the UE, an inference configuration for the two-sided ML model, where the inference configuration includes the identifier and a set of inference parameters. This aspect enables coordinated model deployment with specific operational settings, ensuring both sides of the model pair operate with consistent parameters for optimal inference performance.

Additionally, or alternatively, the NE 1400 may be configured to support selecting the identifier based on a status of the second model part at the NE 1400, where the status is indicative of an applicability of the second model part for inference at the NE 1400. This aspect ensures that only model pairs with applicable components on both sides are activated, preventing partial deployments that would result in inference failures or degraded performance.

Additionally, or alternatively, the NE 1400 may be configured to support the identifier is transmitted as part of a request for the report. This aspect enables targeted status inquiries for specific model pairs, reducing signaling overhead by focusing coordination efforts on relevant models rather than broad capability exchanges.

Additionally, or alternatively, the NE 1400 may be configured to support receiving, from the UE, an updated report indicating a change in the status of the first model part, where the updated report includes the identifier. This aspect enables dynamic model management in response to evolving conditions, allowing the network to maintain optimal model deployments as operational circumstances change across the system.

Additionally, or alternatively, the NE 1400 may be configured to support transmitting a model switching command in response to receiving the report, the model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers. This aspect enables efficient model transitions based on actual UE conditions, providing rapid response to applicability changes without requiring full reconfiguration procedures.

Additionally, or alternatively, the NE 1400 may support at least one memory (e.g., the memory 1404) and at least one processor (e.g., the processor 1402) coupled with the at least one memory and configured to cause the NE 1400 to transmit, to a UE, an identifier for pairing at least two model parts associated with a two-sided ML model, where the two-sided ML model includes a first model part configured for execution at the UE and a second model part configured for execution at the NE 1400, where the identifier identifies whether the first model part is paired with the second model part, and receive, from the UE, a report that indicates a status of the first model part corresponding to the identifier, where the report includes the identifier, and where the status is indicative of an applicability of the first model part for inference at the UE. In this manner, the NE 1400 supports informed model activation decisions that ensure compatible model parts are deployed together for accurate two-sided inference operations.

Additionally, the NE 1400 may be configured to support any one or combination of transmitting, to the UE, an inference configuration for the two-sided ML model, where the inference configuration includes the identifier and a set of inference parameters. This aspect enables coordinated model deployment with specific operational settings, ensuring both sides of the model pair operate with consistent parameters for optimal inference performance.

Additionally, or alternatively, the NE 1400 may be configured to select the identifier based on a status of the second model part at the NE 1400, where the status is indicative of an applicability of the second model part for inference at the NE 1400. This aspect ensures that only model pairs with applicable components on both sides are activated, preventing partial deployments that would result in inference failures or degraded performance.

Additionally, or alternatively, the identifier is transmitted as part of a request for the report. This aspect enables targeted status inquiries for specific model pairs, reducing signaling overhead by focusing coordination efforts on relevant models rather than broad capability exchanges.

Additionally, or alternatively, the NE 1400 may be configured to receive, from the UE, an updated report indicating a change in the status of the first model part, where the updated report includes the identifier. This aspect enables dynamic model management in response to evolving conditions, allowing the network to maintain optimal model deployments as operational circumstances change across the system.

Additionally, or alternatively, the NE 1400 may be configured to transmit a model switching command in response to receiving the report, the model switching command indicating one or more identifiers for pairing at least two model parts and at least one of one or more sets of inference parameters associated with each identifier of the one or more identifiers, one or more inference configurations, one or more switching conditions, or an indication of whether to activate or deactivate a model part corresponding to an identifier of the one or more identifiers. This aspect enables efficient model transitions based on actual UE conditions, providing rapid response to applicability changes without requiring full reconfiguration procedures.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., an LNA) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

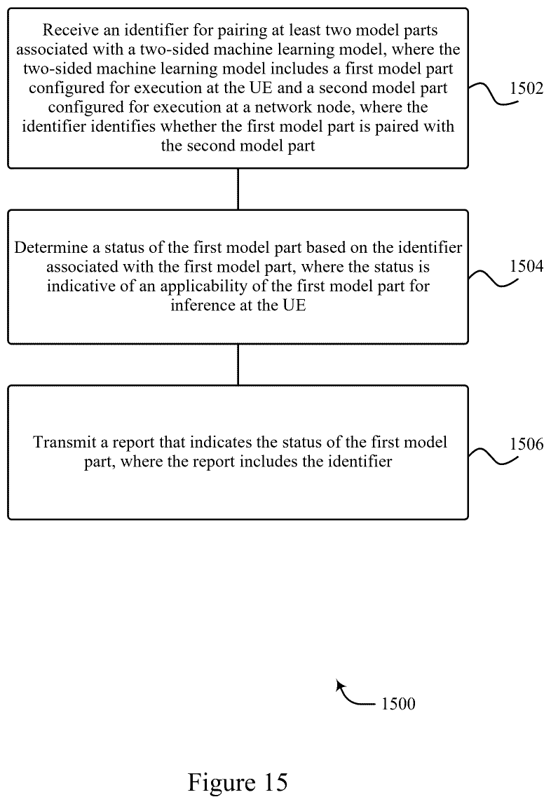

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving an identifier for pairing at least two model parts associated with a two-sided ML model, where the two-sided ML model comprises a first model part configured for execution at the UE and a second model part configured for execution at a network node, where the identifier identifies whether the first model part is paired with the second model part. The operations of 1502 may be performed in accordance with examples as described herein. In some implementations, aspects of the operations of 1502 may be performed by a UE as described with reference to FIG. 12.

At 1504, the method may include determining a status of the first model part based on the identifier associated with the first model part, where the status is indicative of an applicability of the first model part for inference at the UE. The operations of 1504 may be performed in accordance with examples as described herein. In some implementations, aspects of the operations of 1504 may be performed by a UE as described with reference to FIG. 12.

At 1506, the method may include transmitting a report that indicates the status of the first model part, where the report includes the identifier. The operations of 1506 may be performed in accordance with examples as described herein. In some implementations, aspects of the operations of 1506 may be performed a UE as described with reference to FIG. 12.

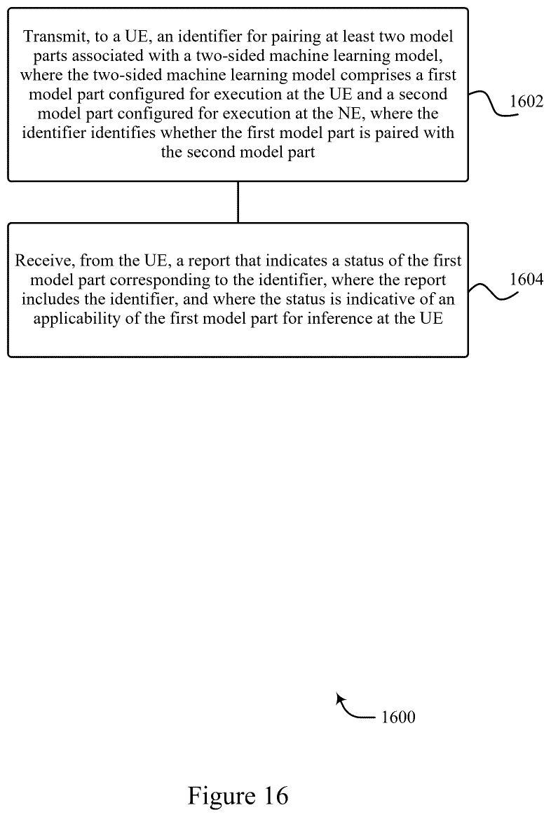

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting, to a UE, an identifier for pairing at least two model parts associated with a two-sided ML model, where the two-sided ML model comprises a first model part configured for execution at the UE and a second model part configured for execution at the NE, where the identifier identifies whether the first model part is paired with the second model part. The operations of 1602 may be performed in accordance with examples as described herein. In some implementations, aspects of the operations of 1602 may be performed by an NE as described with reference to FIG. 14.

At 1604, the method may include receiving, from the UE, a report that indicates a status of the first model part corresponding to the identifier, where the report includes the identifier, and where the status is indicative of an applicability of the first model part for inference at the UE. The operations of 1604 may be performed in accordance with examples as described herein. In some implementations, aspects of the operations of 1604 may be performed by an NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively operable to cause the UE to:
receive an identifier for pairing at least two model parts associated with a two-sided machine learning model, wherein the two-sided machine learning model comprises a first model part configured for execution at the UE and a second model part configured for execution at a network node, wherein the identifier identifies whether the first model part is paired with the second model part;
determine a status of the first model part based at least in part on the identifier associated with the first model part, wherein the status is indicative of an applicability of the first model part for inference at the UE; and
transmit a report that indicates the status of the first model part, wherein the report includes the identifier.

2. The UE of claim 1, wherein the status is determined based at least in part on at least one of a set of inference parameters, an availability of the first model part at the UE, one or more UE conditions, one or more network conditions, one or more deployment criteria associated with the two-sided machine learning model, or one or more training parameters associated with the two-sided machine learning model.

3. The UE of claim 1, wherein the one or more processors are operable to cause the UE to receive an inference configuration for the two-sided machine learning model based at least in part on the report, wherein the inference configuration includes the identifier and a set of inference parameters.

4. The UE of claim 3, wherein the one or more processors are operable to cause the UE to activate the first model part in response to receiving the inference configuration and based at least in part on the status of the first model part being applicable.

5. The UE of claim 3, wherein the inference configuration indicates one or more conditions for activation or deactivation of the first model part at the UE.

6. The UE of claim 1, wherein the report further indicates one or more of:
a respective status and a respective identifier for each two-sided learning model of a set of two-sided machine learning models configured at the UE, or
at least one set of inference parameters associated with the identifier.

7. The UE of claim 1, wherein the one or more processors are operable to cause the UE to transmit, in response to a capability request, a capability report indicating a set of machine learning model functionalities supported by the UE, wherein the identifier is received as part of an inference configuration in response to the capability report, and wherein the inference configuration corresponds to a machine learning model functionality of the set of machine learning model functionalities.

8. The UE of claim 1, wherein the one or more processors are operable to cause the UE to:
detect a change in the status of the first model part; and
transmit an updated report indicating the change in the status, wherein the updated report includes the identifier.

9. The UE of claim 1, wherein the one or more processors are operable to cause the UE to:
receive a model switching command indicating one or more identifiers for pairing at least two model parts and at least one of:
one or more sets of inference parameters associated with each identifier of the one or more identifiers,
one or more inference configurations,
one or more switching conditions, or
an indication of whether to activate or deactivate a model part corresponding to an identifier of the one or more identifiers; and
determine a status of at least one model part corresponding to at least one identifier of the one or more identifiers.

10. The UE of claim 9, wherein the model switching command is received in response to the report or an updated report.

11. The UE of claim 1, wherein the one or more processors are operable to cause the UE to transmit a request to switch to a model part, the request including an identifier associated with the model part.

12. The UE of claim 1, wherein the identifier is associated with a dataset used to train the two-sided machine learning model.

13. A network entity (NE) for wireless communication, comprising:
one or more memories; and
one or more processors coupled with the one or more memories and individually or collectively operable to cause the NE to:
transmit, to a user equipment (UE), an identifier for pairing at least two model parts associated with a two-sided machine learning model, wherein the two-sided machine learning model comprises a first model part configured for execution at the UE and a second model part configured for execution at the NE, wherein the identifier identifies whether the first model part is paired with the second model part; and
receive, from the UE, a report that indicates a status of the first model part corresponding to the identifier, wherein the report includes the identifier, and wherein the status is indicative of an applicability of the first model part for inference at the UE.

14. The NE of claim 13, wherein the one or more processors are operable to cause the NE to transmit, to the UE, an inference configuration for the two-sided machine learning model, wherein the inference configuration includes the identifier and a set of inference parameters.

15. The NE of claim 13, wherein the one or more processors are operable to cause the NE to select the identifier based at least in part on a status of the second model part at the NE, and wherein the status is indicative of an applicability of the second model part for inference at the NE.

16. The NE of claim 13, wherein the identifier is transmitted as part of a request for the report.

17. The NE of claim 13, wherein the one or more processors are operable to cause the NE to receive, from the UE, an updated report indicating a change in the status of the first model part, wherein the updated report includes the identifier.

18. The NE of claim 13, wherein the one or more processors are operable to cause the NE to transmit a model switching command in response to receiving the report, the model switching command indicating one or more identifiers for pairing at least two model parts and at least one of:
one or more sets of inference parameters associated with each identifier of the one or more identifiers,
one or more inference configurations,
one or more switching conditions, or
an indication of whether to activate or deactivate a model part corresponding to an identifier of the one or more identifiers.

19. A method performed by a user equipment (UE), the method comprising:
receiving an identifier for pairing at least two model parts associated with a two-sided machine learning model, wherein the two-sided machine learning model comprises a first model part configured for execution at the UE and a second model part configured for execution at a network node, wherein the identifier identifies whether the first model part is paired with the second model part;
determining a status of the first model part based at least in part on the identifier associated with the first model part, wherein the status is indicative of an applicability of the first model part for inference at the UE; and
transmitting a report that indicates the status of the first model part, wherein the report includes the identifier.

20. A method performed by a network entity (NE), the method comprising:
transmitting, to a user equipment (UE), an identifier for pairing at least two model parts associated with a two-sided machine learning model, wherein the two-sided machine learning model comprises a first model part configured for execution at the UE and a second model part configured for execution at the NE, wherein the identifier identifies whether the first model part is paired with the second model part; and
receiving, from the UE, a report indicating a status of the first model part corresponding to the identifier, wherein the report includes the identifier, and wherein the status is indicative of an applicability of the first model part for inference at the UE.
